(19) United States
(12) Patent Application Publication
(10) Pub. No.: US 2025/0282445 A1
(43) Pub. Date: Sep. 11, 2025

(54) ASSIST DEVICE FOR HUMAN-POWERED VEHICLE, TRANSMISSION DEVICE FOR HUMAN-POWERED VEHICLE, AND CONTROL SYSTEM FOR HUMAN-POWERED VEHICLE

(71) Applicant: Shimano Inc., Osaka (JP)

(72) Inventors: Akihiro NOZAKI, Osaka (JP); Tomohiro TAKIMOTO, Osaka (JP)

(21) Appl. No.: 19/044,228

(22) Filed: Feb. 3, 2025

(30) Foreign Application Priority Data
Mar. 5, 2024 (JP) 2024-033043

(51) Int. Cl. B62M 6/55; B62M 6/45; B62M 25/08

(52) U.S. Cl. CPC B62M 6/55; B62M 6/45; B62M 25/08

(57) ABSTRACT

An assist device for a human-powered vehicle includes an assist motor, a first communicator, and a first controller. The first communicator communicates with a transmission device and receives first information from the transmission device. The first controller controls the first communicator so that the first communicator transmits a predetermined signal to the transmission device in order to actuate the transmission device and change a transmission ratio. The transmission device changes the transmission ratio by moving a chain between two adjacent ones of sprockets. The first controller acquires a predetermined period based on the first information received by the first communicator. The first controller controls the first communicator so that the first communicator transmits the predetermined signal to the transmission device in accordance with the predetermined period. The first information includes information related to transmission stages corresponding to the transmission ratio and a rotational amount of the sprockets.

### CROSS-REFERENCE TO RELATED APPLICATIONS

This application claims priority to Japanese Patent Application No. 2024-033043, filed on Mar. 5, 2024. The entire disclosure of Japanese Patent Application No. 2024-033043 is hereby incorporated herein by reference.

### BACKGROUND

### Technical Field

The present disclosure generally relates to an assist device for a human-powered vehicle, a transmission device for a human-powered vehicle, and a control system for a human-powered vehicle.

### Background Information

Japanese Laid-Open Patent Publication No. 2018-089989 (Patent Document 1) discloses an example of a control device for a human-powered vehicle configured to control a transmission device.

### SUMMARY

An objective of the present disclosure is to provide an assist device for a human-powered vehicle, a transmission device for a human-powered vehicle, and a control system for a human-powered vehicle that change a transmission ratio in a preferred manner.

An assist device in accordance with a first aspect of the present disclosure is for a human-powered vehicle. The assist device comprises an assist motor, a first communicator, and a first controller. The assist motor is configured to assist in propulsion of the human-powered vehicle. The first communicator is configured to communicate with a transmission device and receive first information from the transmission device. The transmission device is configured to change a transmission ratio of the human-powered vehicle. The first controller is configured to control the first communicator so that the first communicator transmits a predetermined signal to the transmission device in order to actuate the transmission device and change the transmission ratio. The transmission device is configured to change the transmission ratio by moving a chain between two adjacent sprockets of a plurality of sprockets. The first controller is configured to acquire a predetermined period based on the first information received by the first communicator. The first controller is configured to control the first communicator so that the first communicator transmits the predetermined signal to the transmission device in accordance with the predetermined period. The first information includes information related to a plurality of transmission stages corresponding to the transmission ratio and a rotational amount of the plurality of sprockets.

With the assist device according to the first aspect, the first controller changes the transmission ratio with the transmission device in accordance with the predetermined period acquired based on the first information received from the transmission device. Therefore, the first controller changes the transmission ratio in a preferred manner.

An assist device in accordance with a second aspect of the present disclosure is for a human-powered vehicle. The assist device comprises an assist motor, a first communicator, and a first controller. The assist motor is configured to assist in propulsion of the human-powered vehicle. The first communicator is configured to wirelessly communicate with a transmission device and receive predetermined information from the transmission device. The transmission device is configured to change a transmission ratio of the human-powered vehicle. The first controller is configured to control the first communicator so that the first communicator transmits a predetermined signal to the transmission device in order to actuate the transmission device and change the transmission ratio. The first controller is configured to acquire a predetermined period based on the predetermined information received by the first communicator. The first controller is configured to control the first communicator so that the first communicator transmits the predetermined signal to the transmission device in accordance with the predetermined period.

With the assist device according to the second aspect, the first controller changes the transmission ratio with the transmission device in accordance with the predetermined period acquired based on the predetermined information received from the transmission device through wireless communication.

In accordance with a third aspect of the present disclosure, the assist device according to the second aspect is configured so that the transmission device is configured to change the transmission ratio by moving a chain between two adjacent sprockets of a plurality of sprockets. The predetermined information includes at least one of first information and second information. The first information includes information related to a plurality of transmission stages corresponding to the transmission ratio and a rotational amount of the plurality of sprockets. The second information includes at least one of identification information of the transmission device and identification information of a set of the plurality of sprockets.

With the assist device according to the third aspect, the first controller acquires the predetermined period based on at least one of the first information and the second information.

In accordance with a fourth aspect of the present disclosure, the assist device according to the third aspect is configured so that the predetermined information includes the first information. The first controller is configured to acquire the predetermined period based on the first information and a changing direction of the transmission ratio.

With the assist device according to the fourth aspect, the first controller acquires the predetermined period based on the first information and the changing direction of the transmission ratio.

In accordance with a fifth aspect of the present disclosure, the assist device according to the third aspect is configured so that the predetermined information includes the first information. The first information includes a table indicating a corresponding relationship of the plurality of transmission stages and the rotational amount.

With the assist device according to the fifth aspect, the first controller changes the transmission ratio with the transmission device in accordance with the predetermined period acquired based on the table.

An assist device in accordance with a sixth aspect of the present disclosure is for a human-powered vehicle. The assist device comprises an assist motor, a first communicator, and a first controller. The assist motor is configured to assist in propulsion of the human-powered vehicle. The first communicator is configured to wirelessly communicate with a transmission device that is configured to change a transmission ratio of the human-powered vehicle. The first controller is configured to control the first communicator so that the first communicator transmits a predetermined signal to the transmission device in order to actuate the transmission device and change the transmission ratio. The transmission device is configured to change the transmission ratio by moving a chain between two adjacent sprockets of a plurality of sprockets. The first controller is configured to control the first communicator so that the first communicator transmits the predetermined signal to the transmission device in accordance with the predetermined period. The first controller is configured to acquire the predetermined period based on a rotational amount of the plurality of sprockets, a present transmission ratio that is presently set, and a changing direction of the transmission ratio. The rotational amount is set for each of the plurality of transmission stages corresponding to the transmission ratio.

With the assist device according to the sixth aspect, the first controller changes the transmission ratio with the transmission device in accordance with the predetermined period acquired based on the rotational amount of the sprockets, the present transmission ratio, and the changing direction of the transmission ratio. Therefore, the first controller changes the transmission ratio in a preferred manner.

In accordance with a seventh aspect of the present disclosure, the assist device according to any one of the first to sixth aspects is configured so that in a case where the predetermined signal is transmitted in response to a first changing request and then a second changing request is set, the first controller is configured to control the first communicator so that the first communicator transmits the predetermined signal to the transmission device in response to the second changing request in accordance with the predetermined period.

With the assist device according to the seventh aspect, in a case where multiple changing requests are set, the first controller transmits the predetermined signal to the transmission device in accordance with the predetermined period.

In accordance with an eighth aspect of the present disclosure, the assist device according to any one of the first to sixth aspects is configured so that in a case where the predetermined signal is transmitted in response to a first changing request and then a second changing request is set before the predetermined period elapses from a time point at which changing of the transmission ratio performed in response to the first changing request is completed, the first controller is configured to control the first communicator so that the first communicator transmits the predetermined signal to the transmission device in response to the second changing request after the predetermined period elapses.

With the assist device according to the eighth aspect, in a case where multiple changing requests are set, the first controller transmits the predetermined signal to the transmission device after the predetermined period elapses.

In accordance with a ninth aspect of the present disclosure, the assist device according to any one of the first and third to sixth aspects is configured so that the rotational amount is set based on a transmission facilitation region provided on each of the plurality of sprockets.

With the assist device according to the ninth aspect, the first controller optimally changes the transmission ratio with the transmission device in accordance with the rotational amount of the sprockets that is set based on the transmission facilitation region provided on each of the sprockets.

In accordance with a tenth aspect of the present disclosure, the assist device according to any one of the first to ninth aspects is configured so that the predetermined period is acquired based on at least one of a rotational speed of a crank axle of the human-powered vehicle and a vehicle speed.

With the assist device according to the tenth aspect, the first controller optimally changes the transmission ratio with the transmission device in accordance with the predetermined period acquired based on at least one of the rotational speed of the crank axle and the vehicle speed.

A transmission device in accordance with an eleventh aspect of the present disclosure is for a human-powered vehicle. The transmission device is configured to change a transmission ratio of the human-powered vehicle by moving a chain between two adjacent sprockets of a plurality of sprockets. The transmission device comprises an actuator, a second communicator, and a second controller. The actuator is configured to actuate the transmission device and change the transmission ratio. The second communicator is configured to communicate with an assist device that assists in propulsion of the human-powered vehicle to receive a predetermined signal from the assist device and transmit first information to the assist device. The second controller is configured to control the actuator based on the predetermined signal received by the second communicator. The predetermined signal is transmitted to the second communicator in accordance with a predetermined period acquired by the assist device based on the first information. The first information includes information related to a plurality of transmission stages corresponding to the transmission ratio and a rotational amount of the plurality of sprockets.

With the transmission device according to the eleventh aspect, the second controller changes the transmission ratio based on the predetermined signal received in accordance with the predetermined period. Therefore, the first controller changes the transmission ratio in a preferred manner.

In accordance with a twelfth aspect of the present disclosure, the transmission device according to the eleventh aspect is configured so that in a case where the second communicator is connected to the assist device in a manner allowing for communication, the second controller is configured to control the second communicator so that the second communicator transmits the first information to the assist device.

With the transmission device according to the twelfth aspect, the second controller transmits the first information to the assist device. This allows the assist device to optimally change the transmission ratio in response to the predetermined signal transmitted in accordance with the predetermined period.

A transmission device in accordance with a thirteenth aspect of the present disclosure is for a human-powered vehicle. The transmission device is configured to change a transmission ratio of the human-powered vehicle. The transmission device comprises an actuator, a second communicator, and a second controller. The actuator is configured to actuate the transmission device and change the transmission ratio. The second communicator is configured to wirelessly communicate with an assist device that assists in propulsion of the human-powered vehicle to receive a predetermined signal from the assist device and transmit predetermined information to the assist device. The second controller is configured to control the actuator based on the predetermined signal received by the second communicator. The predetermined signal is transmitted to the second communicator in accordance with a predetermined period acquired by the assist device based on the predetermined information.

With the transmission device according to the thirteenth aspect, the second controller changes the transmission ratio based on the predetermined signal received in accordance with the predetermined period through wireless communication. Thus, the second controller changes the transmission ratio in a preferred manner.

In accordance with a fourteenth aspect of the present disclosure, the transmission device according to the thirteenth aspect is configured so that the transmission device is configured to change the transmission ratio by moving a chain between two adjacent sprockets of a plurality of sprockets. The predetermined information includes at least one of first information and second information. The first information includes information related to a plurality of transmission stages corresponding to the transmission ratio and a rotational amount of the plurality of sprockets. The second information includes at least one of identification information of the transmission device and identification information of a set of the plurality of sprockets.

With the transmission device according to the fourteenth aspect, the second controller controls the second communicator so that the second communicator transmits at least one of the first information and the second information for acquiring the predetermined period to the assist device.

In accordance with a fifteenth aspect of the present disclosure, the transmission device according to the fourteenth aspect is configured so that the predetermined information includes the first information. The assist device is configured to acquire the predetermined period based on the first information and a changing direction of the transmission ratio.

With the transmission device according to the fifteenth aspect, the second controller optimally performs shifting in response to the predetermined signal transmitted from the assist device in accordance with the predetermined period acquired based on the first information and the changing direction of the transmission ratio.

In accordance with a sixteenth aspect of the present disclosure, the transmission device according to the fourteenth aspect is configured so that the predetermined information includes the first information. The first information includes a table indicating a corresponding relationship of the plurality of transmission stages and the rotational amount.

With the transmission device according to the sixteenth aspect, the second controller optimally performs shifting in response to the predetermined signal transmitted from the assist device in accordance with the predetermined period acquired based on the table.

In accordance with a seventeenth aspect of the present disclosure, the transmission device according to any one of the thirteenth to sixteenth aspects is configured so that in a case where the second communicator is connected to the assist device in a manner allowing for communication, the second controller is configured to control the second communicator so that the second communicator transmits the predetermined information to the assist device.

With the transmission device according to the seventeenth aspect, the second controller transmits the first information to the assist device in a case where the second controller is connected to the assist device.

A transmission device in accordance with an eighteenth aspect of the present disclosure is for a human-powered vehicle. The transmission device is configured to change a transmission ratio of the human-powered vehicle by moving a chain between two adjacent sprockets of a plurality of sprockets. The transmission device comprises an actuator, a second communicator, and a second controller. The actuator is configured to actuate the transmission device and change the transmission ratio. The second communicator is configured to wirelessly communicate with an assist device that assists in propulsion of the human-powered vehicle to receive a predetermined signal from the assist device. The second controller is configured to control the actuator based on the predetermined signal received by the second communicator. The predetermined signal is transmitted to the second communicator in accordance with a predetermined period acquired by the assist device. The predetermined period is acquired based on a rotational amount of the plurality of sprockets, a present transmission ratio that is presently set, and a changing direction of the transmission ratio. The rotational amount is set for each of the plurality of transmission stages corresponding to the transmission ratio.

With the transmission device according to the eighteenth aspect, the second controller optimally changes the transmission ratio in response to the predetermined signal transmitted from the assist device in accordance with the predetermined period acquired based on the rotational amount of the sprockets, the present transmission ratio, and the changing direction of the transmission ratio.

In accordance with a nineteenth aspect of the present disclosure, the transmission device according to any one of the eleventh to eighteenth aspects is configured so that in a case where a changing request is set, the assist device is configured to transmit the predetermined signal to the second communicator after the predetermined period elapses from a time point at which the changing request is set. The second controller is configured to control the actuator in order to change the transmission ratio in a case where the predetermined signal is received.

With the transmission device according to the nineteenth aspect, the second controller changes the transmission ratio in response to the predetermined signal transmitted from the assist device after the predetermined period elapses. This reduces the calculation load on the second controller.

In accordance with a twentieth aspect of the present disclosure, the transmission device according to any one of the eleventh to eighteenth aspects is configured so that the predetermined signal includes information related to the predetermined period. The second controller is configured to restrict driving of the actuator after operation of the transmission device ends until a wait period based on the predetermined period elapses.

With the transmission device according to the twentieth aspect, the second controller optimally changes the transmission ratio in accordance with the wait period.

A transmission device in accordance with a twenty-first aspect of the present disclosure is for a human-powered vehicle. The transmission device is configured to change a transmission ratio of the human-powered vehicle by moving a chain between two adjacent sprockets of a plurality of sprockets. The transmission device comprises an actuator and a second controller. The actuator is configured to actuate the transmission device and change the transmission ratio. The second controller is configured to control the actuator. In a case where the transmission device is actuated to change the transmission ratio, the second controller is configured to control the actuator so that the actuator delays operation initiation of the transmission device for a predetermined period acquired based on a rotational amount of the plurality of sprockets, a present transmission ratio that is presently set, and a changing direction of the transmission ratio. The rotational amount is set for each of the plurality of transmission stages corresponding to the transmission ratio.

With the transmission device according to the twenty-first aspect, the second controller delays operation initiation of the transmission device for the predetermined period and changes the transmission ratio in a preferred manner.

In accordance with a twenty-second aspect of the present disclosure, the transmission device according to the twenty-first aspect is configured so that in a case where the actuator is controlled to change the transmission ratio in response to a first changing request and then a second changing request is set, the second controller is configured to control the actuator so that the actuator changes the transmission ratio in response to the second changing request in accordance with the predetermined period.

With the transmission device according to the twenty-second aspect, the second controller optimally changes the transmission ratio in accordance with the predetermined period.

In accordance with a twenty-third aspect of the present disclosure, the transmission device according to the twenty-first or twenty-second aspect is configured so that in a case where the actuator is controlled to change the transmission ratio in response to a first changing request and then a second changing request is set before the predetermined period elapses from a time point at which changing of the transmission ratio performed in response to the first changing request is completed, the second controller is configured to control the actuator so that the actuator changes the transmission ratio in response to the second changing request after the predetermined period elapses.

With the transmission device according to the twenty-third aspect, the second controller ensures that shifting is performed by changing the transmission ratio after the predetermined period elapses.

In accordance with a twenty-fourth aspect of the present disclosure, the transmission device according to any one of the eleventh, twelfth, fourteenth to sixteenth, eighteenth, and twenty-first to twenty-third aspects is configured so that the rotational amount is set based on a transmission facilitation region provided on each of the plurality of sprockets.

With the transmission device according to the twenty-fourth aspect, the second controller optimally changes the transmission ratio in accordance with the rotational amount of the sprockets set based on the transmission facilitation region provided on each of the sprockets.

In accordance with a twenty-fifth aspect of the present disclosure, the transmission device according to any one of the eleventh to twenty-fourth aspects is configured so that the predetermined period is acquired based on at least one of a rotational speed of a crank axle of the human-powered vehicle and a vehicle speed.

With the transmission device according to the twenty-fifth aspect, the second controller optimally changes the transmission ratio in accordance with the predetermined period acquired based on at least one of the rotational speed of the crank axle and the vehicle speed.

A control system in accordance with a twenty-sixth aspect of the present disclosure is for a human-powered vehicle. The control system comprises the assist device according to any one of the first to tenth aspects, and the transmission device.

With the control system according to the twenty-sixth aspect, the transmission device optimally changes the transmission ratio in response to the predetermined signal transmitted from the assist device in accordance with the predetermined period.

In accordance with a twenty-seventh aspect of the present disclosure, the control system according to the twenty-sixth aspect further comprises a transmission operating device configured to operate the transmission device. The transmission device includes a third communicator configured to communicate with the transmission operating device through a first communication protocol. The assist device is configured to communicate with the transmission device through a second communication protocol that differs from the first communication protocol.

With the control system according to the twenty-seventh aspect, the transmission device communicates with the assist device through the second communication protocol that differs from the first communication protocol through which the transmission device communicates with the transmission operating device.

In accordance with a twenty-eighth aspect of the present disclosure, the control system according to the twenty-sixth or twenty-seventh aspect is configured so that the transmission device and the assist device are supplied with electric power from a common battery.

With the control system according to the twenty-eighth aspect, the assist device supplies electric power to the transmission device in a preferred manner.

The assist device for a human-powered vehicle, the transmission device for a human-powered vehicle, and the control system for a human-powered vehicle in accordance with the present disclosure change the transmission ratio in a preferred manner.

### BRIEF DESCRIPTION OF THE DRAWINGS

Referring now to the attached drawings which form a part of this original disclosure, an illustrative embodiment is shown.

FIG. 1 is a side elevational view of a human-powered vehicle (e.g., a bicycle) including a human-powered vehicle control device in accordance with illustrated embodiments.

FIG. 2 is a block diagram showing the electrical configuration of the human-powered vehicle control device in accordance with a first embodiment.

FIG. 3 is a flowchart illustrating a control process executed by a first controller shown in FIG. 2 to control an assist device of the human-powered vehicle illustrated in FIG. 1.

FIG. 4 is a flowchart illustrating a control process executed by a second controller shown in FIG. 2 to control a transmission device of the human-powered vehicle illustrated in FIG. 1.

FIG. 5 is a flowchart illustrating a control process executed by the first controller shown in FIG. 2 to control the assist device.

FIG. 6 is a flowchart illustrating a control process executed by the second controller shown in FIG. 2 to control the transmission device.

FIG. 7 is a flowchart illustrating a control process executed by a first controller in accordance with a second embodiment to control an assist device of the human-powered vehicle illustrated in FIG. 1.

FIG. 8 is a flowchart illustrating a control process executed by a second controller in accordance with the second embodiment to control a transmission device of the human-powered vehicle illustrated in FIG. 1.

FIG. 9 is a flowchart illustrating a control process executed by a second controller in accordance with a third embodiment to control a transmission device of the human-powered vehicle illustrated in FIG. 1.

FIG. 10 is a flowchart illustrating a control process executed by a second controller of a modification to control a transmission device of the human-powered vehicle illustrated in FIG. 1.

### DETAILED DESCRIPTION

Selected embodiments will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

### First Embodiment

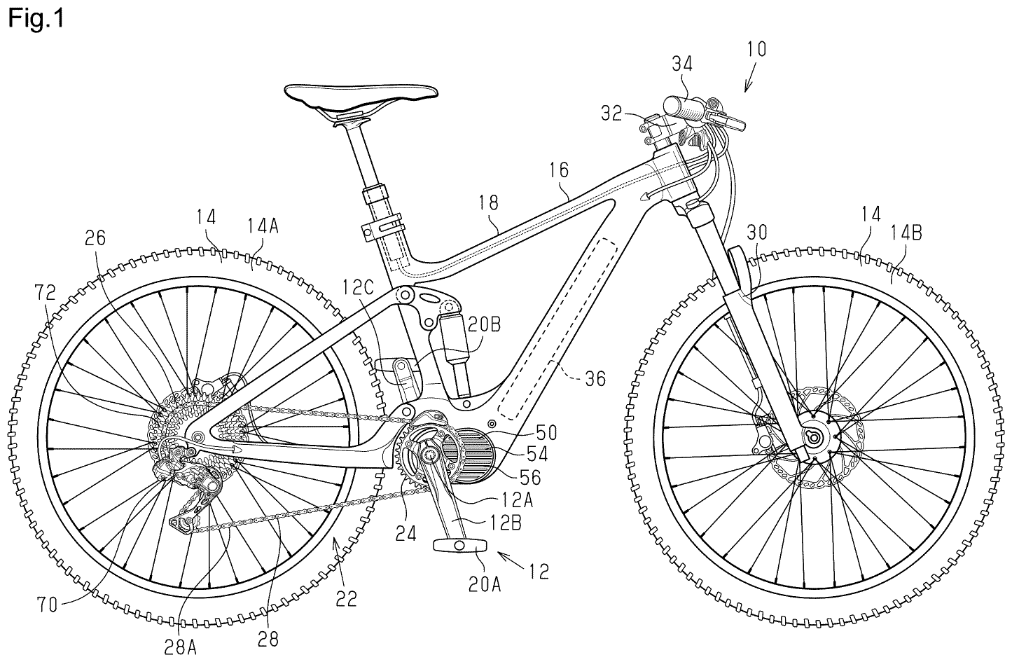

Referring initially to FIG. 1, a human-powered vehicle 10 is illustrated for the illustrated embodiments. An assist device 50, a transmission device 70, and a control system 40 in accordance with a first embodiment will now be described with reference to FIGS. 1 to 6. The control system 40, the assist device 50 and the transmission device 70 are each provided to the human-powered vehicle 10 illustrated in FIG. 1.

The human-powered vehicle 10 is a vehicle that includes at least one wheel and can be driven by at least a human driving force. The human-powered vehicle 10 includes, for example, various types of bicycles, such as a mountain bike, a road bike, a city bike, a cargo bike, a handcycle, or a recumbent bike. There is no limit to the number of wheels of the human-powered vehicle 10. The human-powered vehicle 10 also includes, for example, a unicycle or vehicles having two or more wheels. The human-powered vehicle 10 is not limited to a vehicle that can be driven by only a human driving force. The human-powered vehicle 10 includes an electric bicycle (E-bike) that uses a driving force of an electric motor for propulsion in addition to the human driving force. The E-bike includes an electric assist bicycle that assists in propulsion with an electric motor. In each embodiment described below, the human-powered vehicle 10 will be referred to as an electric assist bicycle.

In the present specification, the frame of reference for the terms indicating directions such as “front”, “rear”, “forward”, “rearward”, “left”, “right”, “sideward”, “upward”, and “downward”, as well as other analogous terms indicating directions, will be based on the view of a rider who is facing the handlebar from a reference position (e.g., on saddle or seat) of the human-powered vehicle.

As shown in FIG. 1, the human-powered vehicle 10 includes, for example, a crank 12 to which a human driving force is input. The human-powered vehicle 10 includes, for example, a wheel 14 and a vehicle body 16. The wheel 14 includes, for example, a drive wheel 14A and a driven wheel 14B. The drive wheel 14A is, for example, a rear wheel of the human-powered vehicle 10. The driven wheel 14B is, for example, a front wheel of the human-powered vehicle 10. The drive wheel 14A can be the front wheel of the human-powered vehicle 10. In a case where the drive wheel 14A is the front wheel, the driven wheel 14B is the rear wheel.

The vehicle body 16 includes, for example, a frame 18. The crank 12 includes, for example, a crank axle 12A and two crank arms 12B and 12C. The crank axle 12A is rotatable relative to the frame 18. The two crank arms 12B and 12C are provided on two axial ends of the crank axle 12A, respectively. Two pedals 20A and 20B are coupled to the crank arms 12B and 12C, respectively. For example, rotation of the crank 12 drives the drive wheel 14A. The drive wheel 14A is, for example, supported by the frame 18.

The crank 12 is, for example, linked to the drive wheel 14A by a drive mechanism 22. The drive mechanism 22 includes, for example, a first rotational body 24 coupled to the crank axle 12A. The crank axle 12A and the first rotational body 24 can be coupled to each other so as to rotate integrally. Alternatively, the crank axle 12A and the first rotational body 24 can be coupled to each other by a first one-way clutch. The first one-way clutch is, for example, configured to rotate the first rotational body 24 forward in a case where the crank 12 is rotated forward. The first one-way clutch is, for example, configured to allow relative rotation of the crank 12 and the first rotational body 24 in a case where the crank 12 is rotated rearward. The first rotational body 24 includes, for example, a sprocket, a pulley, or a bevel gear.

The drive mechanism 22 further includes, for example, a second rotational body 26 and a linking member 28. The linking member 28 transmits the rotational force of the first rotational body 24 to the second rotational body 26. The linking member 28 includes, for example, a chain 28A, a belt, or a shaft.

The second rotational body 26 is, for example, coupled to the drive wheel 14A. The second rotational body 26 includes, for example, a sprocket, a pulley, or a bevel gear. For example, a second one-way clutch is provided in a power transmission path of the human driving force between the second rotational body 26 and the drive wheel 14A. The second one-way clutch is, for example, configured to rotate the drive wheel 14A forward in a case where the second rotational body 26 is rotated forward. The second one-way clutch is, for example, configured to allow relative rotation of the second rotational body 26 and the drive wheel 14A in a case where the second rotational body 26 is rotated rearward.

The driven wheel 14B is, for example, attached to the frame 18 by a front fork 30. A handlebar 34 is connected to the front fork 30 by a stem 32. In the present embodiment, the drive wheel 14A is linked to the crank 12 by the drive mechanism 22. At least one of the drive wheel 14A and the driven wheel 14B can be linked to the crank 12 by the drive mechanism 22.

The human-powered vehicle 10 further includes a battery 36. The battery 36 includes, for example, one or more battery cells. Each battery cell includes, for example, a rechargeable battery. The battery 36 is, for example, configured to supply electric power to the assist device 50 and the transmission device 70. For example, the battery 36 is connected to a first controller 60 and a second controller 78 via an electric cable or a wireless communication device in a manner allowing for communication. The battery 36 is configured to communicate with the first controller 60 and the second controller 78 through, for example, power line communication (PLC), Controller Area Network (CAN), or universal asynchronous receiver-transmitter (UART).

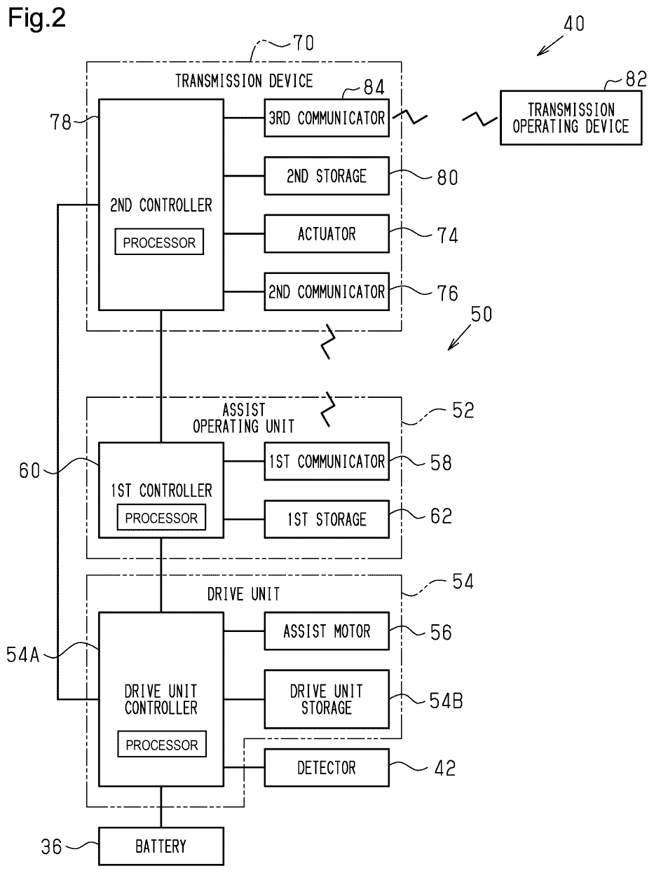

As shown in FIG. 2, the control system 40 includes, for example, the assist device 50 and the transmission device 70. For example, the transmission device 70 and the assist device 50 are supplied with electric power from the common battery 36. The transmission device 70 can be supplied with the electric power from a battery that differs from the battery 36. The transmission device 70 is, for example, electrically connected to the assist device 50. The battery 36 supplies electric power to the transmission device 70 via the assist device 50.

The control system 40 further includes, for example, a detector 42 that detects at least one of a traveling state of the human-powered vehicle 10 and a traveling environment of the human-powered vehicle 10. The detector 42 is, for example, configured to detect the traveling state of the human-powered vehicle 10. The traveling state includes, for example, at least one of a rotational speed C of the crank axle 12A, a human driving force input to the crank 12, a force input to the pedals 20A and 20B, and a vehicle speed. The term “detector” as used herein refers to a hardware device or instrument designed to detect the presence or absence of a particular event, object, substance, or a change in its environment, and to emit a signal in response to the detection. The term “detector” as used herein do not include a human being.

The detector 42 includes, for example, at least one of a human driving force detector, a crank rotational state detector, and a vehicle speed detector. The detector 42 is, for example, electrically connected to a drive unit controller 54A by a wire or in a wireless manner. The human driving force includes at least one of a human torque input to the crank 12 and a force input to the pedals 20A and 20B. The crank rotational state includes the rotational speed C of the crank axle 12A. A transmission state includes at least one of an operational state of the transmission device 70 corresponding to at least one of a transmission ratio R and a transmission stage, and an operational state of a transmission operating device 82 corresponding to at least one of the transmission ratio R and the transmission stage.

In the case where the detector 42 is the human driving force detector, the human driving force detector is provided, for example, in a drive unit 54. The human driving force detector is arranged, for example, in an interior cavity formed in a housing of the drive unit 54. The human driving force detector is provided, for example, on a member included in a transmission path of human driving force. The member included in the transmission path of human driving force includes, for example, the crank axle 12A or a member rotated in cooperation with the crank axle 12A.

The human driving force detector is, for example, configured to output a signal corresponding to torque applied to the crank axle 12A by the human driving force. The signal corresponding to the torque applied to the crank axle 12A by the human driving force includes information related to the human driving force input to the crank 12. The human driving force detector includes, for example, a strain sensor, a magnetostrictive sensor, or a pressure sensor. A strain sensor includes, for example, a strain gauge. The human driving force detector can have any configuration as long as information related to human driving force is detected.

The human driving force detector does not have to be provided in the drive unit 54. The human driving force detector can be provided on the crank arms 12B and 12C or the pedals 20A and 20B. In a case where the human driving force detector is provided on the pedals 20A and 20B, the human driving force detector can include a sensor that detects the pressure applied to the pedals 20A and 20B. The human driving force detector can be provided on the chain 28A. In a case where the human driving force detector is provided on the chain 28A, the human driving force detector can include a sensor that detects the tension on the chain 28A.

In the case where the detector 42 is the crank rotational state detector, the crank rotational state detector is provided, for example, in the drive unit 54. The crank rotational state detector is arranged, for example, in the internal cavity formed in the housing of the drive unit 54. The crank rotational state detector is configured to detect information corresponding to the rotational speed C of the crank axle 12A. The information corresponding to the rotational speed C of the crank axle 12A includes, for example, angular acceleration of the crank axle 12A. The angular acceleration of the crank axle 12A corresponds to, for example, acceleration of the human-powered vehicle 10. The information corresponding to the rotational speed C of the crank axle 12A includes, for example, information related to cadence of the human-powered vehicle 10.

The crank rotational state detector includes, for example, at least one of a magnetic sensor, an acceleration sensor, an optical sensor, a gyro sensor, and a torque sensor. The crank rotational state detector includes, for example, a magnetic sensor that outputs a signal corresponding to the strength of a magnetic field. The magnetic sensor includes, for example, a ring-shaped magnet having a magnetic field that changes in the circumferential direction. The ring-shaped magnet having the magnetic field that changes in the circumferential direction is provided, for example, on a member included in the transmission path of human driving force. The member included in the transmission path of human driving force includes, for example, the crank axle 12A or a member rotated in cooperation with the crank axle 12A. The crank rotational state detector outputs, for example, a signal corresponding to the rotational speed C of the crank axle 12A.

The crank rotational state detector can include an acceleration sensor, instead of the magnetic sensor. The crank rotational state detector can include an optical sensor, a gyro sensor, or a torque sensor, instead of the magnetic sensor. The crank rotational state detector can have any configuration as long as information corresponding to the rotational speed C of the crank axle 12A is detected.

The crank rotational state detector is, for example, configured to output a predetermined number of detection signals during a period in which the crank axle 12A completes one rotation. The predetermined number is, for example, two or greater. The predetermined number is, for example, four or greater. The predetermined number is, for example, a multiple of four. The predetermined number is, for example, eight, twelve, or sixteen.

The crank rotational state detector does not have to be provided in the drive unit 54. The crank rotational state detector is provided, for example, on the frame 18. In a case where the crank rotational state detector is not provided in the drive unit 54, the crank rotational state detector can include a vehicle speed sensor. In a case where the crank rotational state detector includes a vehicle speed sensor, for example, the drive unit controller 54A is configured to calculate the rotational speed C of the crank axle 12A from the vehicle speed detected by the vehicle speed sensor and the transmission ratio R.

In the case where the detector 42 is the vehicle speed detector, the vehicle speed detector is provided, for example, on the frame 18. The vehicle speed detector is, for example, configured to detect information related to the speed of the human-powered vehicle 10. The vehicle speed detector is, for example, configured to detect information related to a rotational speed W of the wheel 14 of the human-powered vehicle 10. The vehicle speed detector is, for example, configured to detect a magnet provided on at least one of the front wheel and the rear wheel.

The vehicle speed detector is, for example, configured to output a predetermined number of detection signals during a period in which the wheel 14 completes one rotation. The predetermined number is, for example, one. The vehicle speed detector outputs, for example, a signal corresponding to the rotational speed W of the wheel 14. The drive unit controller 54A is, for example, configured to calculate the speed of the human-powered vehicle 10 based on the signal corresponding to the rotational speed W of the wheel 14 and information related to the circumferential length of the wheel 14. The information related to the circumferential length of the wheel 14 is stored, for example, in a first storage 62.

The assist device 50 includes, for example, an assist operating unit 52 and the drive unit 54. For example, the assist operating unit 52 is formed separately from the drive unit 54. The assist operating unit 52 is provided, for example, at a position separated from the drive unit 54. The assist operating unit 52 includes, for example, a housing that is separate from the housing of the drive unit 54. The assist operating unit 52 is provided, for example, on the human-powered vehicle 10 at a position operable by the rider. The assist operating unit 52 is provided, for example, on the handlebar 34 or a top tube of the frame 18. The assist operating unit 52 can be configured to operate a human-powered vehicle component other than the drive unit 54.

The assist device 50 for a human-powered vehicle includes, for example, an assist motor 56, a first communicator 58, and the first controller 60. The drive unit 54 is, for example, configured to apply a propulsion force to the human-powered vehicle 10. The drive unit 54 includes, for example, the assist motor 56. The assist motor 56 assists in, for example, propulsion of the human-powered vehicle 10. The assist motor 56 is, for example, a brushless motor.

The assist operating unit 52 includes, for example, the first controller 60. The first controller 60 includes, for example, a computer that executes predetermined control programs. The computer includes, for example, a central processing unit (CPU) or a micro-processing unit (MPU). The first controller 60 includes, for example, at least one processor that executes predetermined control programs. The first controller 60 can include one or more microcomputers. The first controller 60 can include multiple processors arranged at separate locations. The first controller 60 can be formed of one or more semiconductor chips that are mounted on a printed circuit board. The first controller 60 can also be referred to as a first electronic controller 60. The terms “controller” and “electronic controller” as used herein refer to hardware that executes a software program, and does not include a human being.

The assist operating unit 52 includes, for example, the first storage 62. The first storage 62 stores, for example, control programs and information used for control processes. The first storage 62 includes, for example, at least one of a non-volatile memory and a volatile memory. A non-volatile memory includes, for example, at least one of a read-only memory (ROM), an erasable programmable read-only memory (EPROM), and an electrically erasable programmable read-only memory (EEPROM), and a flash memory. A volatile memory includes, for example, a random-access memory (RAM). The first storage 62 is any computer storage device or any non-transitory computer-readable medium with the sole exception of a transitory, propagating signal. For example, the first storage 62 is electrically connected to the first controller 60 by a wire or in a wireless manner.

The assist operating unit 52 includes, for example, the first communicator 58. The first communicator 58 is, for example, configured to wirelessly communicate with the transmission device 70 that is configured to change the transmission ratio R of the human-powered vehicle 10. The first communicator 58 can be configured to perform wired communication with the transmission device 70. In the present embodiment, the first communicator 58 wirelessly communicate with a second communicator 76 of the transmission device 70. For example, the first communicator 58 is electrically connected to the first controller 60 by a wire or in a wireless manner. Term “communicator” as used herein refers to the communication interface or device that is a hardware device capable of transmitting an analog or digital signal either via a communication wire, or wirelessly. In other words, the term “communicator” as used herein refers to hardware and does not include a human being.

The drive unit 54 further includes, for example, the drive unit controller 54A. The drive unit controller 54A includes, for example, a computer that executes predetermined control programs. The computer includes, for example, a CPU or an MPU. The drive unit controller 54A includes, for example, at least one processor that executes predetermined control programs. The drive unit controller 54A can include one or more microcomputers. The drive unit controller 54A can include multiple processors arranged at separate locations. The drive unit controller 54A can be formed of one or more semiconductor chips that are mounted on a printed circuit board. The drive unit controller 54A can also be referred to as an electronic drive unit controller 54A. For example, the drive unit controller 54A is connected to the first controller 60 by a wire. The drive unit controller 54A can be wirelessly connected to the first controller 60. The drive unit controller 54A and the first controller 60 can be the same controller.

The drive unit 54 further includes, for example, drive unit storage 54B. The drive unit storage 54B stores, for example, control programs and information used for control processes. The drive unit storage 54B includes, for example, at least one of a non-volatile memory and a volatile memory. A non-volatile memory includes, for example, at least one of a ROM, an EPROM, an EEPROM, and a flash memory. A volatile memory includes, for example, a RAM. For example, the drive unit storage 54B is connected to the drive unit controller 54A in a manner allowing for wired communication or wireless communication.

The drive unit 54 further includes, for example, the housing. The assist motor 56, the drive unit controller 54A, and the drive unit storage 54B are provided in the housing. The drive unit controller 54A and the drive unit storage 54B are provided, for example, on an electric circuit board accommodated in the housing.

The drive unit 54 can further include a drive circuit of the assist motor 56. The drive circuit of the assist motor 56 is arranged, for example, in the internal cavity formed in the housing of the drive unit 54. For example, the drive circuit of the assist motor 56 is electrically connected to the drive unit controller 54A by a wire or in a wireless manner. The drive circuit of the assist motor 56 drives the assist motor 56, for example, in response to a control signal from the drive unit controller 54A.

The drive circuit of the assist motor 56 is, for example, configured to control the supply of electric power from the battery 36 to the assist motor 56. The drive circuit of the assist motor 56 includes, for example, an inverter circuit. The inverter circuit includes, for example, a plurality of transistors. The inverter circuit includes, for example, a configuration in which multiple inverter units are connected in parallel. Each of the inverter units is formed by two transistors connected in series. The inverter circuit can include a current sensor that detects a current flowing through the inverter circuit. For example, the current sensor is electrically connected to the drive unit controller 54A by a wire or in a wireless manner.

The drive unit controller 54A is, for example, configured to control the assist motor 56. The drive unit controller 54A is, for example, configured to control the assist motor 56 in accordance with the traveling state of the human-powered vehicle 10. The drive unit controller 54A is, for example, configured to control the assist motor 56 so as to change the propulsion force applied to the human-powered vehicle 10 in accordance with the human driving force input to the human-powered vehicle 10.

The drive unit controller 54A can be configured to control the assist motor 56 in accordance with the human driving force detected by the human driving force detector (the detector 42). The drive unit controller 54A can be configured to control the assist motor 56 in accordance with the rotational speed C of the crank axle 12A detected by the crank rotational state detector. The drive unit controller 54A can be configured to control the assist motor 56 in accordance with the rotational speed W of the wheel 14 detected by the vehicle speed detector. The drive unit controller 54A can be configured to control the assist motor 56 in accordance with information transmitted from outside the drive unit 54. The information transmitted from outside the drive unit 54 includes, for example, an operation signal from the assist operating unit 52.

The transmission device 70 is, for example, configured to change the transmission ratio R of the human-powered vehicle 10. The transmission device 70 is provided, for example, in the transmission path of human driving force in the human-powered vehicle 10. The transmission ratio R is, for example, a ratio of the rotational speed W of the wheel 14 to the rotational speed C of the crank axle 12A. The rotational speed W of the wheel 14 includes, for example, a rotational speed of the drive wheel 14A. The rotational speed W of the wheel 14 and the rotational speed C of the crank axle 12A can each be the number of rotations per unit time. In the transmission ratio R, the rotational speed W of the wheel 14 can be replaced by the number of teeth of at least one first rotational body 24, and the rotational speed C of the crank axle 12A can be replaced by the number of teeth of at least one second rotational body 26. The relationship of the transmission ratio R, the rotational speed W of the wheel 14, and the rotational speed C of the crank axle 12A satisfies the following Equation (1).

R=W/C Equation (1):

The transmission device 70 includes, for example, a plurality of transmission stages. For example, each of the transmission stages corresponds to a different transmission ratio R. For example, the transmission ratio R increases as the transmission stage increases. In a case where the smallest transmission stage is selected, the transmission ratio R is the smallest transmission ratio R obtainable by the transmission device 70. In a case where the largest transmission stage is selected, the transmission ratio R is the largest transmission ratio R obtainable by the transmission device 70.

The transmission device 70 includes, for example, a derailleur. For example, the derailleur moves the linking member 28 engaged with one of a plurality of sprockets 72 to another one of the sprockets 72. The transmission device 70 is, for example, configured to change the transmission ratio R of the human-powered vehicle 10 by moving the chain 28A between two adjacent ones of the sprockets 72. The transmission device 70 is, for example, configured to change the transmission ratio R of the human-powered vehicle 10 in a stepped manner by moving the chain 28A between two adjacent ones of the sprockets 72. The transmission device 70 operates the chain 28A and changes the engagement state between the sprockets 72 and the chain 28A so as to change the transmission stage.

The transmission device 70 performs a changing action for changing the transmission ratio R. The changing action includes, for example, an action performed by the derailleur to operate the chain 28A so as to change the transmission ratio R. The changing action includes, for example, an action moving the chain 28A between two adjacent ones of the sprockets 72. The changing action includes an upshifting action performed by the derailleur. The changing action includes a downshifting action performed by the derailleur.

The derailleur includes, for example, at least one of a front derailleur and a rear derailleur. In a case where the derailleur includes a front derailleur, the first rotational body 24 includes a front sprocket. In a case where the derailleur includes a front derailleur, the sprockets 72 include a plurality of front sprockets. The number of front sprockets is, for example, in a range of two to four, inclusive.

In a case where the derailleur includes a front derailleur, for example, the number of transmission stages coincides with the number of front sprockets. In a case where the derailleur includes a front derailleur, for example, one of the front sprockets having the most teeth corresponds to the largest transmission stage obtainable by the derailleur. In a case where the derailleur includes a front derailleur, for example, one of the front sprockets having the least teeth corresponds to the smallest transmission stage obtainable by the derailleur.

In a case where the derailleur includes a rear derailleur, the second rotational body 26 includes a rear sprocket. In a case where the derailleur includes a rear derailleur, the sprockets 72 include a plurality of rear sprockets. The number of rear sprockets is, for example, in a range of three to thirty, inclusive.

In a case where the derailleur includes a rear derailleur, for example, the number of transmission stages coincides with the number of rear sprockets. In a case where the derailleur includes a rear derailleur, for example, one of the rear sprockets having the least teeth corresponds to the largest transmission stage obtainable by the derailleur. In a case where the derailleur includes a rear derailleur, for example, one of the rear sprockets having the most teeth corresponds to the smallest transmission stage obtainable by the derailleur. In the present embodiment, the transmission device 70 will be described as a rear derailleur.

The transmission device 70 for a human-powered vehicle includes, for example, an actuator 74, the second communicator 76, and the second controller 78. The actuator 74 is, for example, configured to actuate the transmission device 70 and change the transmission ratio R. The actuator 74 includes, for example, a transmission motor.

The second controller 78 includes, for example, a computer that executes predetermined control programs. The computer includes, for example, a CPU or an MPU. The second controller 78 includes, for example, at least one processor that executes predetermined control programs. The second controller 78 can include one or more microcomputers. The second controller 78 can include multiple processors arranged at separate locations. The second controller 78 can be formed of one or more semiconductor chips that are mounted on a printed circuit board. The second controller 78 can also be referred to as a second electronic controller 78.

The second controller 78 is provided, for example, in a housing of the transmission device 70. The second controller 78 is provided, for example, in the same housing as the actuator 74. The second controller 78 is provided, for example, on at least one of a base member, an outer link member, an inner link member, a movable member, an outer guide plate, and an inner guide plate of the rear derailleur.

The transmission device 70 further includes, for example, a second storage 80. The second storage 80 stores, for example, control programs and information used for control processes. The second storage 80 includes, for example, at least one of a non-volatile memory and a volatile memory. A non-volatile memory includes, for example, at least one of a ROM, an EPROM, an EEPROM, and a flash memory. A volatile memory includes, for example, a RAM. The second storage 80 is any computer storage device or any non-transitory computer-readable medium with the sole exception of a transitory, propagating signal. For example, the second storage 80 is electrically connected to the second controller 78 by a wire or in a wireless manner.

The second storage 80 is provided, for example, in the housing of the transmission device 70. The second storage 80 is provided, for example, in the same housing as the actuator 74. The second storage 80 is provided, for example, on at least one of the base member, the outer link member, the inner link member, the movable member, the outer guide plate, and the inner guide plate of the rear derailleur.

The second communicator 76 is, for example, configured to communicate with the assist device 50 that assists in propulsion of the human-powered vehicle 10. The second communicator 76 is, for example, configured to wirelessly communicate with the assist device 50 that assists in propulsion of the human-powered vehicle 10. The second communicator 76 can be configured to perform wired communication with the assist device 50. In the present embodiment, the second communicator 76 wirelessly communicates with the first communicator 58 of the assist device 50. For example, the second communicator 76 is electrically connected to the second controller 78 by a wire or in a wireless manner. The second communicator 76 can be configured to communicate with a communicator that differs from the first communicator 58. The second communicator 76 can be configured to perform wired communication or wireless communication with the drive unit controller 54A. The first communicator 58 and the second communicator 76 can communicate via wired communication using power line communication (PLC), Controller Area Network (CAN), or universal asynchronous receiver-transmitter (UART), and can communicate via wireless communication using, for example, ANT®, ANT+®, Bluetooth®, Wi-Fi®, or ZigBee®.

The control system 40 includes, for example, the transmission operating device 82 configured to operate the transmission device 70. The transmission operating device 82 includes, for example, an operation unit operated by a user. The operating unit receives, for example, an operation performed by the user. The operating unit includes at least one of a switch, a lever, and a dial. Thus, the transmission operating device 82 can also be referred to as a user input, or a user operable input.

The operating unit includes, for example, a first operating portion for increasing the transmission ratio R and a second operating portion for decreasing the transmission ratio R. In a case where the first operating portion is operated, for example, the transmission operating device 82 transmits a signal that sets a changing request for increasing the transmission ratio R to at least one of the first controller 60 and the drive unit controller 54A. In a case where the second operating portion is operated, for example, the transmission operating device 82 transmits a signal that sets a changing request for decreasing the transmission ratio R to at least one of the first controller 60 and the drive unit controller 54A.

The transmission device 70 includes, for example, a third communicator 84 configured to communicate with the transmission operating device 82 through a first communication protocol. The third communicator 84 is, for example, configured to perform wireless communication or wired communication with the transmission operating device 82. The third communicator 84 can communicate via wired communication using power line communication (PLC), Controller Area Network (CAN), or universal asynchronous receiver-transmitter (UART), and can communicate via wireless communication using, for example, ANT®, ANT+®, Bluetooth®, Wi-Fi®, or ZigBee®. The assist device 50 is, for example, configured to communicate with the transmission device 70 through a second communication protocol that differs from the first communication protocol. In the present embodiment, the assist operating unit 52 is configured to communicate with the transmission device 70 through the second communication protocol.

At least one of the first controller 60 and the drive unit controller 54A sets a changing request, for example, in a case where a changing condition is satisfied. At least one of the first controller 60 and the drive unit controller 54A determines whether the changing condition is satisfied, for example, by comparing a predetermined threshold value with a parameter related to at least one of the traveling state of the human-powered vehicle 10 and the traveling environment of the human-powered vehicle 10. At least one of the first controller 60 and the drive unit controller 54A can determine whether the changing condition is satisfied, for example, based on whether the first operating portion or the second operating portion of the transmission operating device 82 is operated by the user.

The predetermined threshold value includes, for example, at least one of an upper limit value and a lower limit value. At least one of the first controller 60 and the drive unit controller 54A sets a changing request, for example, in a case where the parameter related to at least one of the traveling state and the traveling environment of the human-powered vehicle 10 is greater than the upper limit value. At least one of the first controller 60 and the drive unit controller 54A sets a changing request, for example, in a case where the parameter related to at least one of the traveling state and the traveling environment of the human-powered vehicle 10 is less than the lower limit value. For example, the predetermined threshold value can be set constant or vary in accordance with a present transmission ratio R that is presently set.

The parameter includes, for example, at least one of the human driving force input to the human-powered vehicle 10, the rotational speed C of the crank axle 12A of the human-powered vehicle 10, the speed of the human-powered vehicle 10, and a pitch angle of the human-powered vehicle 10. The first controller 60 can select at least two parameters from the human driving force input to the human-powered vehicle 10, the rotational speed C of the crank axle 12A of the human-powered vehicle 10, the speed of the human-powered vehicle 10, and the pitch angle of the human-powered vehicle 10, and combine the selected parameters to obtain a new parameter. The first controller 60 can calculate a new parameter based on the relationship of the selected parameters.

In a case where the parameter is greater than the upper limit value, for example, the first controller 60 controls the transmission device 70 to increase the transmission ratio R. In a case where the parameter is greater than the upper limit value, the first controller 60 can control the transmission device 70 to decrease the transmission ratio R. In a case where the parameter is less than the lower limit value, for example, the first controller 60 controls the transmission device 70 to decrease the transmission ratio R. In a case where the parameter is less than the lower limit value, the first controller 60 can control the transmission device 70 to increase the transmission ratio R.

The first controller 60 can be configured to increase the upper limit value in a case where the transmission ratio R increases. If the first controller 60 is configured to increase the upper limit value in a case where the transmission ratio R increases, the first controller 60 becomes less likely to execute a control that increases the transmission ratio R as the transmission ratio R increases. The first controller 60 can be configured to decrease the upper limit value in a case where the transmission ratio R increases. If the first controller 60 is configured to decrease the upper limit value in a case where the transmission ratio R increases, the first controller 60 becomes more likely to execute a control that increases the transmission ratio R as the transmission ratio R increases.

The first controller 60 can be configured to increase the lower limit value in a case where the transmission ratio R decreases. If the first controller 60 is configured to increase the lower limit value in a case where the transmission ratio R decreases, the controller 60 becomes more likely to execute a control that decreases the transmission ratio R as the transmission ratio R decreases. The first controller 60 can be configured to decrease the lower limit value in a case where the transmission ratio R decreases. If the first controller 60 is configured to decrease the lower limit value in a case where the transmission ratio R decreases, the first controller 60 becomes less likely to execute a control that decreases the transmission ratio R as the transmission ratio R decreases.

In a case where the parameter is greater than the upper limit value, for example, the first controller 60 controls the transmission device 70 to change the transmission ratio R so that the parameter becomes less than or equal to the upper limit value. In a case where the parameter is less than the lower limit value, for example, the first controller 60 controls the transmission device 70 to change the transmission ratio R so that the parameter becomes greater than or equal to the lower limit value.

In a case where the parameter has a negative correlation with a load on the rider, for example, the first controller 60 controls the transmission device 70 to increase the transmission ratio R if the parameter is greater than the upper limit value. In a case where the parameter has a negative correlation with the load on the rider, for example, the first controller 60 controls the transmission device 70 to decrease the transmission ratio R if the parameter is less than the lower limit value. The parameter having a negative correlation with the load on the rider includes, for example, at least one of the rotational speed C of the crank axle 12A and the speed of the human-powered vehicle 10.

In a case where the parameter has a positive correlation with the load on the rider, for example, the first controller 60 controls the transmission device 70 to decrease the transmission ratio R if the parameter is greater than the upper limit value. In a case where the parameter has a positive correlation with the load on the rider, for example, the first controller 60 controls the transmission device 70 to increase the transmission ratio R if the parameter is less than the lower limit value. The parameter having a positive correlation with the load on the rider includes, for example, at least one of the human driving force and the pitch angle of the human-powered vehicle 10.

In a case where the parameter related to at least one of the traveling state and traveling environment of the human-powered vehicle 10 becomes greater than the predetermined threshold value, for example, at least one of the first controller 60 and the drive unit controller 54A sets a changing request for increasing the transmission ratio R. In a case where the parameter related to at least one of the traveling state and traveling environment of the human-powered vehicle 10 becomes less than the predetermined threshold value, for example, at least one of the first controller 60 and the drive unit controller 54A sets a changing request for decreasing the transmission ratio R.

In a case where a changing request is set, the first controller 60 controls the first communicator 58 so that the first communicator 58 transmits to the second communicator 76 a predetermined signal that initiates a changing action by the transmission device 70 in response to the changing request. In a case where a first changing request is set, for example, the first controller 60 is configured to control the first communicator 58 so that the first communicator 58 transmits a first signal based on the first changing request to the second communicator 76. In a case where multiple changing requests are successively set as the changing condition is satisfied, for example, the first changing request corresponds to the initial changing request. In a case where the first changing request is set as the changing condition is satisfied, for example, the assist device 50 is configured to transmit the first signal to the second communicator 76 without a wait period.

In a case where a second changing request is set, for example, the first controller 60 is configured to control the first communicator 58 so that the first communicator 58 transmits a second signal based on the second changing request to the second communicator 76. In a case where multiple changing requests are successively set as the changing condition is satisfied, for example, the second changing request corresponds to a changing request set after the first changing request.

The first controller 60 is, for example, configured to control the first communicator 58 so that the first communicator 58 transmits the predetermined signal to the transmission device 70 in order to actuate the transmission device 70 and change the transmission ratio R in response to the changing request. The predetermined signal includes, for example, a changing initiation signal. In a case where the changing request is the first changing request, for example, the first controller 60 is configured to control the first communicator 58 so that the first communicator 58 immediately transmits the predetermined signal to the transmission device 70. The first controller 60 is, for example, configured to control the first communicator 58 so that the first communicator 58 transmits the predetermined signal to the transmission device 70 in order to actuate the transmission device 70 and change the transmission ratio R. The first controller 60 is, for example, configured to control the first communicator 58 so that the first communicator 58 transmits a predetermined signal corresponding to a changing direction. The predetermined signal includes, for example, either one of a shift-up signal or a shift-down signal. In a case where the first controller 60 controls the transmission device 70 to increase the transmission ratio R, the first controller 60 transmits a shift-up signal to the transmission device 70. In a case where the first controller 60 controls the transmission device 70 to decrease the transmission ratio R, the first controller 60 transmits a shift-down signal to the transmission device 70.

The second communicator 76 is, for example, configured to receive the predetermined signal from the assist device 50. The second controller 78 is, for example, configured to control the actuator 74 based on the predetermined signal received by the second communicator 76. The second controller 78 is, for example, configured to control the actuator 74 in order to change the transmission ratio R in a case where the predetermined signal is received. The second controller 78 is, for example, configured to control the actuator 74 in order to immediately change the transmission ratio R in a case where the predetermined signal is received. In other words, for example, the second controller 78 is configured to control the actuator 74 in order to change the transmission ratio R without a wait period in a case where the predetermined signal is received.

The second controller 78 is, for example, configured to control the second communicator 76 so that the second communicator 76 transmits a changing completion signal to the first communicator 58 after the transmission device 70 completes a changing action. The second controller 78 is, for example, configured to control the second communicator 76 so that the second communicator 76 transmits a changing completion signal to the first communicator 58 after the transmission device 70 completes a changing action corresponding to a single changing request.

The second controller 78 transmits the changing completion signal to the assist device 50, for example, as the second controller 78 ends driving of the actuator 74. For example, the transmission device 70 can include a transmission state detector and transmit the changing completion signal to the assist device 50 in accordance with an output of the transmission state detector. For example, the first communicator 58 receives the changing completion signal from the transmission device 70. The first controller 60 is, for example, configured to control the first communicator 58 so that the first communicator 58 receives the changing completion signal from the transmission device 70. In a case where the changing completion signal is received from the transmission device 70, for example, the first controller 60 determines that operation of the transmission device 70 is completed.

The transmission state detector is provided, for example, on the actuator 74. The transmission state detector is configured to detect information related to the present transmission stage. The transmission state detector includes, for example, a sensor that outputs a signal in accordance with actuation of the actuator 74. The transmission state detector can include at least one of a magnetic sensor, an optical sensor, and a potentiometer. In a case where the transmission device 70 includes a derailleur, the transmission state detector can be provided on the derailleur or a portion of the frame 18 peripheral to the derailleur.

In a case where the transmission device 70 includes a derailleur, for example, the information related to the present transmission stage includes at least one of information related to actuation of the actuator 74, a position of the movable member of the derailleur with respect to the frame 18, and a rotational phase of the movable member. The movable member includes, for example, a chain guide. In a case where the transmission state detector detects at least one of the position of the movable member with respect to the frame 18 and the rotational phase of the movable member, for example, the transmission state detector detects the magnetic force of a magnet provided on one of the frame 18 or the movable member so as to obtain at least one of the position of the movable member with respect to the frame 18 and the rotational phase of the movable member.

The transmission state detector transmits, for example, a detection signal to the second controller 78 in fixed time intervals. In a case where the second controller 78 determines that shifting is completed based on the detection signal transmitted from the transmission state detector, for example, the second controller 78 is configured to transmit the changing completion signal to the first controller 60.

The information related to actuation of the actuator 74 can include a rotational speed of the actuator 74 detected by a magnetic sensor. In a case where the transmission state detector detects the rotational speed of the actuator 74, for example, the transmission state detector detects the rotational speed of a rotational shaft in the actuator 74. The derailleur can further include a speed reducer connected to the actuator 74. A speed reducer includes, for example, a plurality of gears. In a case where the derailleur includes the speed reducer, the information related to actuation of the actuator 74 can include a rotational speed of a gear included in the speed reducer. In a case where the transmission state detector detects the rotational speed of the gear included in the speed reducer, for example, the transmission state detector detects the magnetic force of a magnet provided on the gear of the speed reducer.

The drive unit controller 54A and the first controller 60 can obtain the detection signal transmitted from the transmission state detector. The first controller 60 can be configured to directly receive the detection signal transmitted from the transmission state detector. The drive unit controller 54A and the first controller 60 can receive the detection signal of the transmission state detector and determine that changing of the transmission ratio R is completed based on the detection signal of the transmission state detector. The drive unit controller 54A and the first controller 60 can determine whether changing of the transmission ratio R is completed based on the rotational speed C of the crank axle 12A and the rotational speed W of the wheel 14. In a case where the human driving force is greater than or equal to a threshold value specified in advance, the drive unit controller 54A and the first controller 60 can be configured to calculate the transmission ratio R from the rotational speed C of the crank axle 12A and the rotational speed W of the wheel 14.

In a case where the transmission device 70 is actuated, at least one of the first controller 60 and the second controller 78 can control the transmission device 70 so that an inching control is executed. The inching control includes control executed after operation of the transmission device 70 is completed if a detection value of the rotational speed of the actuator 74 or a detection value of the rotational speed of the gear in the speed reducer obtained by the transmission state detector differs from a specified value stored in advance. The inching control further actuates the actuator 74 to reduce such a difference. In a case where the transmission device 70 is controlled so that the inching control is executed, the transmission device 70 can be configured to transmit the changing completion signal to the first controller 60 upon completion of the inching control.

The first controller 60 is, for example, configured to control the first communicator 58 so that the first communicator 58 transmits the predetermined signal to the transmission device 70 in accordance with a predetermined period. For example, the predetermined signal is transmitted to the second communicator 76 in accordance with the predetermined period acquired by the assist device 50. In a case where a changing request is set, for example, the assist device 50 is configured to transmit the predetermined signal to the second communicator 76 after the predetermined period elapses from a time point at which the changing request is set. In a case where the second changing request is set, for example, the assist device 50 is configured to transmit the predetermined signal to the transmission device 70 after the predetermined period elapses from a time point at which the second changing request is set.

In the present embodiment, for example, in a case where the predetermined signal is transmitted in response to the first changing request and then the second changing request is set, the first controller 60 is configured to control the first communicator 58 so that the first communicator 58 transmits the predetermined signal to the transmission device 70 in response to the second changing request in accordance with the predetermined period. In the present embodiment, for example, in a case where the predetermined signal is transmitted in response to the first changing request and then the second changing request is set before the predetermined period elapses from a time point at which changing of the transmission ratio R performed in response to the first changing request is completed, the first controller 60 is configured to control the first communicator 58 so that the first communicator 58 transmits the predetermined signal to the transmission device 70 in response to the second changing request after the predetermined period elapses. In the present embodiment, for example, in a case where the first controller 60 transmits the predetermined signal in response to the first changing request, the first controller 60 is configured to control the first communicator 58 so that the first communicator 58 transmits the predetermined signal to the transmission device 70 without waiting until the predetermined period elapses.

The predetermined period is set to, for example, a period appropriate for initiating shifting in response to the second changing request after a changing completion signal corresponding to the first changing request is received. The predetermined period can be set to a period appropriate for initiating shifting in response to the second changing request after shifting corresponding to the first changing request is initiated.

The predetermined period is, for example, a period that allows for sufficiently completing a changing action by the transmission device 70 in response to a single changing request. The predetermined period is, for example, longer than a period during which the first communicator 58 receives the changing completion signal.

The predetermined period is set to, for example, a period appropriate for sufficiently completing a changing action by the transmission device 70 in response to a single changing request and then initiating a changing action in response to the second changing request. The transmission device 70 performs a changing action based on the first changing request and then performs a changing action based on the second changing request after the predetermined period elapses. This ensures that the transmission ratio R is changed by each one of the transmission stages.

The first controller 60 is, for example, configured to control the first communicator 58 so that the first communicator 58 does not transmit the predetermined signal based on the second changing request until the predetermined period elapses from a time point at which the predetermined signal corresponding to the first changing request is transmitted to the transmission device 70. The first controller 60 is, for example, configured to control the first communicator 58 so that the first communicator 58 does not transmit the predetermined signal based on the second changing request until the predetermined period elapses from a time point at which the changing completion signal corresponding to the first changing request is received from the transmission device 70.

The predetermined signal is, for example, transmitted to the second communicator 76 in accordance with the predetermined period acquired by the assist device 50 based on predetermined information. In the present embodiment, for example, in a case where the second changing request is set, the first controller 60 is configured to control the first communicator 58 so that the first communicator 58 transmits the predetermined signal to the transmission device 70 each time the predetermined period elapses. In a case where three or more changing requests are successively set, for example, the first controller 60 is configured to refer to a second changing request set at the “n”th time as a first changing request that precedes a second changing request set at the “n+1”th time, and control the first communicator 58 so that the first communicator 58 transmits the predetermined signal to the transmission device 70 each time the predetermined period elapses. In this case, “n” is a natural number that is greater than or equal to one.

The predetermined information includes, for example, at least one of first information and second information. The predetermined information includes, for example, the first information. The first information includes, for example, information related to the transmission stages corresponding to the transmission ratio R and a rotational amount of the sprockets 72.

In a case where the predetermined information includes the first information, for example, the first information includes a table indicating a corresponding relationship of the transmission stages and the rotational amount of the sprockets 72. The table indicating the corresponding relationship of the transmission stage and the rotational amount of the sprockets 72 is prepared, for example, for each changing direction. The first information can be a relational expression or a map. The changing direction includes a first changing direction in which the transmission ratio R increases and a second changing direction in which the transmission ratio R decreases.

The same predetermined period can be set for, for example, two or more of the transmission stages. The same predetermined period can be set for, for example, two or more transmission stages in at least one of the first changing direction and the second changing direction. The same predetermined period can be set for, for example, every one of the transmission stages in at least one of the first changing direction and the second changing direction. The predetermined period for a transmission stage that is greater than a first transmission stage can be shorter than the predetermined period for a transmission stage that is less than or equal to the first transmission stage. The predetermined period for the transmission stage that is greater than the first transmission stage in the second changing direction can be shorter than the predetermined period of the transmission stage that is less than or equal to the first transmission stage in the second changing direction. The predetermined period with respect to the second changing direction can be shorter than the predetermined period with respect to the first changing direction.

Table 1 shows an example of the relationship between the transmission stages before and after shifting, the changing direction, and the predetermined period. In Table 1, the minimum value of “S” is two. In Table 1, the maximum value of “S” corresponds to the maximum number of the transmission stages. The total number of the transmission stages is, for example, eleven. The predetermined period in Table 1 corresponds to, for example, the rotational amount of the sprockets 72.

In a case where the transmission stage is changed so that the transmission stage increases, for example, the predetermined period is a period during which the sprockets 72 rotate by a first rotational amount A1. In a case where the transmission stage is changed so that the transmission stage decreases and “S” is in a range of one to “T”, for example, the predetermined period is a period during which the sprockets 72 rotate by a second rotational amount A2. In a case where the transmission stage is changed so that the transmission stage decreases and “S” is in a range of “T+1” to the maximum value, for example, the predetermined period is a period during which the sprockets 72 rotate by a third rotational amount A3. For example, “T” is any natural number of one to nine.

In Table 1, a single predetermined period is prepared with respect to the first changing direction. Alternatively, two or more predetermined periods can be prepared with respect to the first changing direction. In Table 1, two predetermined periods are prepared with respect to the second changing direction. Alternatively, a single predetermined period or three or more predetermined periods can be prepared with respect to the second changing direction. The first rotational amount A1 is, for example, smaller than the second rotational amount A2 and the third rotational amount A3. The second rotational amount A2 is, for example, smaller than the third rotational amount A3.

TABLE 1

| | Transmission | Transmission | |
|---|---|---|---|
| | Stage | Stage | Predetermined |
| | Before Shifting | After Shifting | Period |
| 1st Changing | S − 1 | S | A1 |
| Direction | | | |
| 2nd Changing | S | S − 1 | A2 |
| Direction | (S = 2 to T) | (S = 2 to T) | |
| | S | S − 1 | A3 |
| | (S = T + 1 to | (S = T + 1 to | |
| | Maximum Value) | Maximum Value) | |

The second information includes, for example, at least one of identification information of the transmission device 70 and identification information of the set of the sprockets 72. In a case where the predetermined information includes the second information, for example, the first storage 62 stores in advance the first information associated with at least one of the identification information of the transmission device 70 and the identification information of the set of the sprockets 72. For example, the first storage 62 stores in advance multiple items of the first information respectively corresponding to the identification information of the transmission device 70 and the identification information of the set of the sprockets 72. The first information associated with at least one of the identification information of the transmission device 70 and the identification information of the set of the sprockets 72 can be stored in the first storage 62 via an external device, such as a server or the like.

In a case where the predetermined information includes the second information, the first controller 60 is configured to acquire the predetermined period based on the first information associated with at least one of the identification information of the transmission device 70 and the identification information of the set of the sprockets 72. In a case where the predetermined information includes the second information, the first controller 60 can acquire the predetermined period based on correspondence information in which the second information is directly associated with the predetermined period. For example, the first storage 62 can store the correspondence information in advance. Alternatively, the first controller 60 can acquire the correspondence information from an external device, such as a server or the like.

The predetermined signal is transmitted to the second communicator 76, for example, in accordance with the predetermined period acquired by the assist device 50 based on the first information. The assist device 50 is, for example, configured to acquire the predetermined period based on the first information and the changing direction of the transmission ratio R.

The predetermined period is, for example, acquired based on the rotational amount of the sprockets 72, the present transmission ratio R, and the changing direction of the transmission ratio R. The rotational amount of the sprockets 72 is set for each of the transmission stages corresponding to the transmission ratio R. The first controller 60 is, for example, configured to acquire the predetermined period based on the first information received by the first communicator 58. In a case where the predetermined information includes the first information, for example, the first controller 60 is configured to acquire the predetermined period based on the first information and the changing direction of the transmission ratio R. The first controller 60 is, for example, configured to acquire the predetermined period based on the rotational amount of the sprockets 72 set for each of the transmission stages corresponding to the transmission ratio R, the present transmission ratio R, and the changing direction of the transmission ratio R.

The present transmission ratio R is, for example, a selected one of the plurality of transmission ratios R switchable by the transmission device 70. The present transmission ratio R is, for example, the transmission ratio R at a time point at which the transmission device 70 initiates a changing action. In other words, the present transmission ratio R is the transmission ratio R at a time point before the actuator 74 initiates moving of the chain 28A. The changing direction is, for example, a changing direction of a changing action performed in response to the second changing request.

The rotational amount of the sprockets 72 is, for example, set based on a transmission facilitation region provided on each of the sprockets 72. The transmission facilitation region is, for example, a region extending in a circumferential direction of the rear sprockets. The chain 28A is more readily moved in the transmission facilitation region as compared to outside the region. In a case where the second rotational body 26 includes a plurality of rear sprockets, for example, each of the rear sprockets includes at least one transmission facilitation region. Each of the rear sprockets includes, for example, a different number of transmission facilitation regions. Each of the rear sprockets can include, for example, the same number of transmission facilitation regions.

The transmission facilitation region varies, for example, depending on the changing direction. The transmission facilitation region in the first changing direction is provided on, for example, a rear sprocket around which the chain 28A is wound before moving the chain 28A. The transmission facilitation region in the second changing direction is provided on, for example, a rear sprocket around which the chain 28A is wound after moving the chain 28A. In a case where the transmission ratio R is increased, for example, an angle between multiple transmission facilitation regions on the rear sprocket is an angle between multiple transmission facilitation regions provided with respect to the first changing direction on a rear sprocket around which the chain 28A is wound before moving the chain 28A. In a case where the transmission ratio R is decreased, for example, an angle between multiple transmission facilitation regions on the rear sprocket is to an angle between multiple transmission facilitation regions provided with respect to the second changing direction on a rear sprocket around which the chain 28A is wound after moving the chain 28A.

In a case where a plurality of first rotational bodies 24 includes a plurality of front sprockets, each of the front sprockets can include at least one transmission facilitation region. The transmission facilitation region with respect to the first changing direction is provided on, for example, a front sprocket around which the chain 28A is wound after moving the chain 28A. The transmission facilitation region with respect to the second changing direction is provided on, for example, a front sprocket around which the chain 28A is wound before moving the chain 28A. In a case where the derailleur includes a front derailleur, the angle between multiple transmission facilitation regions on the rear sprocket can be replaced by an angle between multiple transmission facilitation regions on the front sprocket.

The predetermined period can be acquired, for example, based on at least one of the rotational speed C of the crank axle 12A of the human-powered vehicle 10 and the vehicle speed. In a case where the predetermined period is acquired based on the vehicle speed, for example, the first controller 60 is configured to calculate the rotational speed of the rear wheel and the rotational speed of the rear sprocket from the vehicle speed and the transmission stage. The first controller 60 is, for example, configured to calculate the predetermined period based on the rotational speed of the rear sprocket. The predetermined period is, for example, a period that continues until a rotational phase of the rear sprocket based on the rotational speed of the rear sprocket becomes equal to a rotational phase corresponding to the transmission facilitation region of the rear sprocket. The rotational phase corresponding to the transmission facilitation region of the rear sprocket is, for example, a rotational phase at which the chain 28A engages the sprocket teeth included in the transmission facilitation region of the rear sprocket. In a case where the predetermined period is acquired based on the rotational speed of the crank axle 12A, for example, the first controller 60 is configured to calculate a time length during which the rear sprocket rotates until the rotational phase of the rear sprocket becomes equal to the rotational phase corresponding to the transmission facilitation region of the rear sprocket based on the transmission ratio R or the transmission stage, and the rotational speed C of the crank axle 12A.

The first communicator 58 is, for example, configured to wirelessly communicate with the transmission device 70 and receive the predetermined information from the transmission device 70. The first controller 60 is, for example, configured to acquire the predetermined period based on the predetermined information received by the first communicator 58. The first storage 62 is, for example, configured to store the predetermined information received by the first communicator 58. The first storage 62 is configured to update the stored predetermined information. A program for controlling the transmission device 70 with the first controller 60 in accordance with the predetermined information can be downloaded via, for example, the internet or the like. The program for controlling the transmission device 70 with the first controller 60 in accordance with the predetermined information can be, for example, stored in the first storage 62.

The second communicator 76 is, for example, configured to transmit the predetermined information to the assist device 50. In a case where the second communicator 76 is connected to the assist device 50 in a manner allowing for communication, for example, the second controller 78 is configured to control the second communicator 76 so that the second communicator 76 transmits the predetermined information to the assist device 50. The predetermined information is stored, for example, in the second storage 80 in advance. The predetermined information is stored, for example, in the second storage 80 in advance when the transmission device 70 is shipped out of the manufacturing plant. The predetermined information can be stored in the second storage 80 via an external device, such as a server or the like.

In a case where the predetermined information transmitted from the transmission device 70 to the assist device 50 includes the first information, for example, the first communicator 58 is configured to communicate with the transmission device 70 and receive the first information from the transmission device 70. In a case where the predetermined information transmitted from the transmission device 70 to the assist device 50 includes the first information, for example, the second communicator 76 is configured to transmit the first information to the assist device 50. In a case where the predetermined information transmitted from the transmission device 70 to the assist device 50 includes the first information, for example, the second controller 78 is configured to control the second communicator 76 so that the second communicator 76 transmits the first information to the assist device 50 if the second communicator 76 is connected to the assist device 50 in a manner allowing for communication.

In a case where the predetermined information transmitted from the transmission device 70 to the assist device 50 includes the first information, for example, the first storage 62 does not store the first information corresponding to the transmission device 70 when the assist device 50 is shipped out of the manufacturing plant. In a case where the predetermined information transmitted from the transmission device 70 to the assist device 50 includes the first information, for example, if the transmission device 70 included in the control system 40 is changed, the first storage 62 updates the first information stored in the first storage 62 to the first information corresponding to the new transmission device 70.

In a case where the predetermined information transmitted from the transmission device 70 to the assist device 50 includes the first information, the first controller 60 can acquire the predetermined period corresponding to the transmission device 70 based on the first information. Thus, the first controller 60 controls the transmission device 70 in a preferred manner. In a case where the predetermined information transmitted from the transmission device 70 to the assist device 50 includes the first information, the assist device 50 can acquire the first information corresponding to the transmission device 70 directly from the transmission device 70 without using a server or the like. This eliminates the need for a user to obtain the first information from the server or the like, thereby improving usability.

In a case where the predetermined information transmitted from the transmission device 70 to the assist device 50 includes the second information, for example, the first communicator 58 is configured to communicate with the transmission device 70 and receive the second information from the transmission device 70. In a case where the predetermined information transmitted from the transmission device 70 to the assist device 50 includes the second information, for example, the second communicator 76 is configured to transmit the second information to the assist device 50. In a case where the predetermined information transmitted from the transmission device 70 to the assist device 50 includes the second information, for example, the second controller 78 is configured to control the second communicator 76 so that the second communicator 76 transmits the second information to the assist device 50 if the second communicator 76 is connected to the assist device 50 in a manner allowing for communication.

In a case where the predetermined information transmitted from the transmission device 70 to the assist device 50 includes the second information, for example, the first storage 62 stores multiple items of the first information respectively associated with multiple times of the second information. In a case where the predetermined information transmitted from the transmission device 70 to the assist device 50 includes the second information, the first controller 60 acquires the predetermined period using the first information corresponding to the received second information. In a case where the predetermined information transmitted from the transmission device 70 to the assist device 50 includes the second information, the first controller 60 can obtain the first information corresponding to the received second information from an external device, such as a server or the like.

In a case where the predetermined information transmitted from the transmission device 70 to the assist device 50 includes the second information, the first controller 60 can acquire the predetermined period corresponding to the transmission device 70 based on the second information. Thus, the first controller 60 controls the transmission device 70 in a preferred manner.

In a case where the second communicator 76 establishes initial connection with the assist device 50, for example, the second controller 78 is configured to control the second communicator 76 so that the second communicator 76 transmits the predetermined information to the assist device 50. In a case where the first communicator 58 establishes initial connection with the transmission device 70, for example, the first controller 60 is configured to control the first communicator 58 so that the first communicator 58 transmits a predetermined-information sending request to the second communicator 76. A case where the second communicator 76 establishes initial connection with the assist device 50 and a case where the first communicator 58 establishes initial connection with the transmission device 70 include, for example, a case where the assist device 50 is paired with the transmission device 70. The first storage 62 stores, for example, the predetermined information received by the first communicator 58 in a case where the first communicator 58 establishes initial connection with the second communicator 76. In a case where the first communicator 58 establishes connection with the second communicator 76 for a subsequent time, the first controller 60 acquires the predetermined period based on the predetermined information stored in the first storage 62.

The second controller 78 can be configured to control the second communicator 76 so that the second communicator 76 transmits the predetermined information to the assist device 50 each time the second communicator 76 establishes wireless connection with the assist device 50. In this case, for example, the first controller 60 is configured to control the first communicator 58 so that the first communicator 58 transmits a predetermined-information sending request to the second communicator 76 each time the first communicator 58 establishes wireless connection with the transmission device 70.

In a case where the second communicator 76 is connected to the assist device 50 and a system of the assist device 50 is active, the second controller 78 can be configured to control the second communicator 76 so that the second communicator 76 transmits the predetermined information to the assist device 50 each time the transmission device 70 is powered on. In a case where the second communicator 76 is determined as being connected to the first communicator 58, for example, the second controller 78 is configured to control the second communicator 76 so that the second communicator 76 transmits the predetermined information to the first communicator 58 regardless of whether a predetermined-information sending request is issued.

In a case where the second communicator 76 is connected to the assist device 50 and a system of the transmission device 70 is active, the second controller 78 can be configured to control the second communicator 76 so that the second communicator 76 transmits the predetermined information to the assist device 50 each time the assist device 50 is powered on. In a case where the first communicator 58 is determined as being connected to the second communicator 76, for example, the first controller 60 is configured to control the first communicator 58 so that the first communicator 58 transmits a predetermined-information sending request to the second communicator 76.

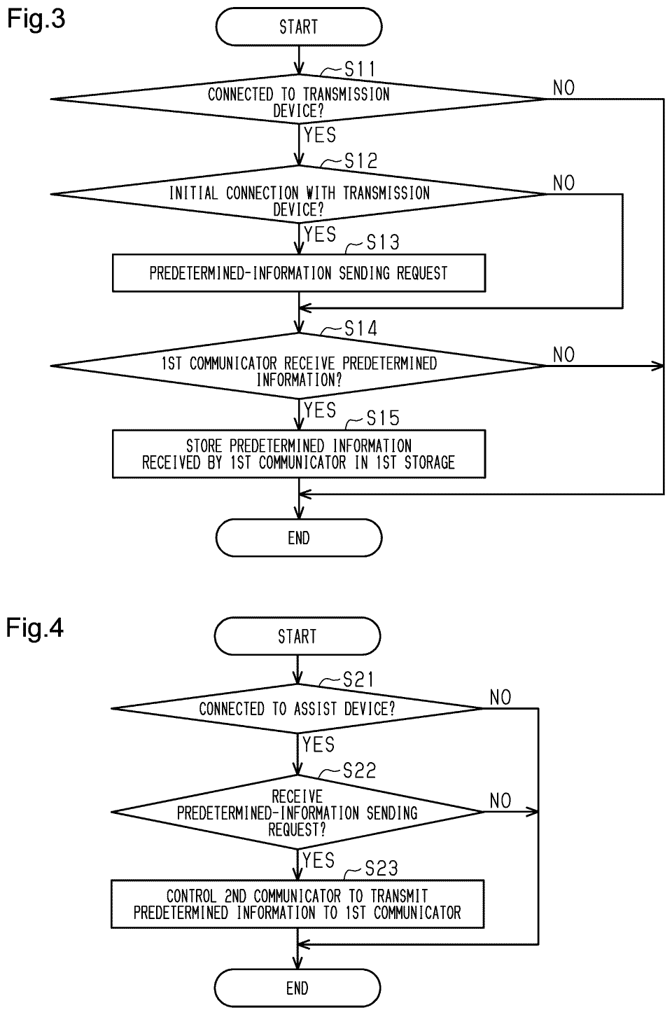

A process executed by the first controller 60 to store the predetermined information will now be described with reference to FIG. 3. In a case where electric power is supplied to the first controller 60, for example, the first controller 60 starts the process of the flowchart shown in FIG. 3 from step S11. In a case where the process of the flowchart shown in FIG. 3 ends, for example, the first controller 60 repeats the process from step S11 of FIG. 3 in predetermined cycles until the supply of electric power is stopped.

In step S11, the first controller 60 determines whether the first controller 60 is connected to the transmission device 70. The first controller 60 determines that the first controller 60 is connected to the transmission device 70, for example, in a case where the first communicator 58 is connected to the second communicator 76. In a case where the first controller 60 is connected to the transmission device 70, the first controller 60 proceeds to step S12. In a case where the first controller 60 is not connected to the transmission device 70, the first controller 60 ends the process.

In step S12, the first controller 60 determines whether the first controller 60 establishes initial connection with the transmission device 70. In a case where the first controller 60 establishes initial connection with the transmission device 70, the first controller 60 proceeds to step S13. In a case where the first controller 60 does not establish initial connection with the transmission device 70, the first controller 60 proceeds to step S14. The first controller 60 determines that the first controller 60 establishes initial connection with the transmission device 70, for example, in a case where the assist device 50 has not been paired with the transmission device 70 and the first communicator 58 is connected to the second communicator 76.

In step S13, the first controller 60 transmits a predetermined-information sending request, and then proceeds to step S14. In step S14, the first controller 60 determines whether the first communicator 58 receives the predetermined information. In a case where the first communicator 58 receives the predetermined information, the first controller 60 proceeds to step S15. In a case where the first communicator 58 does not receive the predetermined information, the first controller 60 ends the process. In step S15, the first controller 60 stores the predetermined information received by the first communicator 58 in the first storage 62, and then ends the process.

A process executed by the second controller 78 to transmit the predetermined information will now be described with reference to FIG. 4. In a case where electric power is supplied to the second controller 78, for example, the second controller 78 starts the process of the flowchart shown in FIG. 4 from step S21. In a case where the process of the flowchart shown in FIG. 4 ends, for example, the second controller 78 repeats the process from step S21 of FIG. 4 in predetermined cycles until the supply of electric power is stopped.

In step S21, the second controller 78 determines whether the second controller 78 is connected to the assist device 50. The second controller 78 determines that the second controller 78 is connected to the assist device 50, for example, in a case where the second communicator 76 is connected to the first communicator 58. In a case where the second controller 78 is connected to the assist device 50, the second controller 78 proceeds to step S22. In a case where the second controller 78 is not connected to the assist device 50, the second controller 78 ends the process.

In step S22, the second controller 78 determines whether a predetermined-information sending request is received. In a case where a predetermined-information sending request is received, the second controller 78 proceeds to step S23. In a case where a predetermined-information sending request is not received, the second controller 78 ends the process. In step S23, the second controller 78 controls the second communicator 76 so that the second communicator 76 transmits the predetermined information to the first communicator 58, and then ends the process.

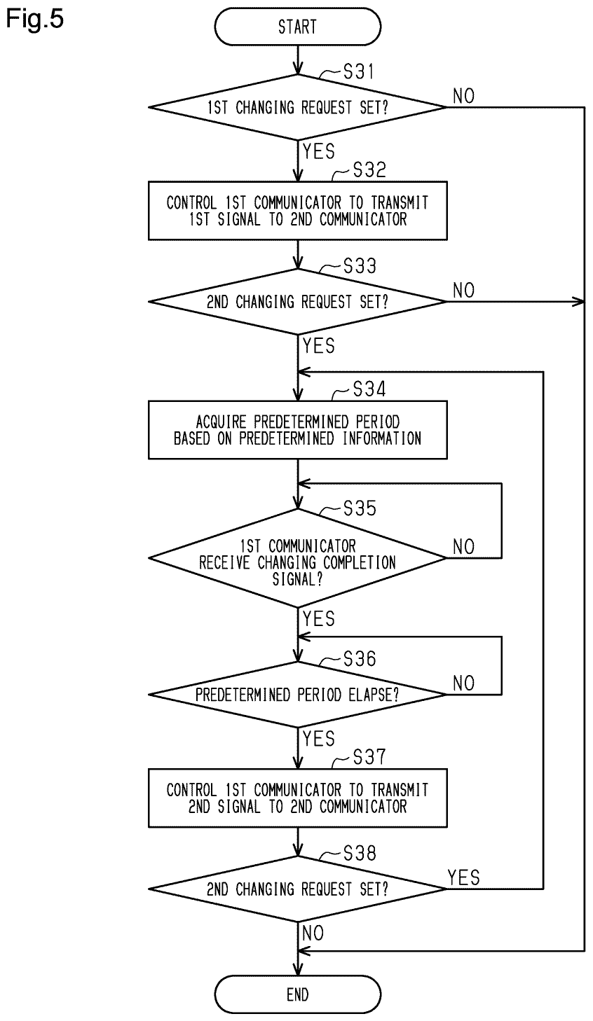

A process executed by the first controller 60 to transmit the predetermined signal to the transmission device 70 in accordance with the predetermined period will now be described with reference to FIG. 5. In a case where electric power is supplied to the first controller 60, for example, the first controller 60 starts the process of the flowchart shown in FIG. 5 from step S31. In a case where the process of the flowchart shown in FIG. 5 ends, for example, the first controller 60 repeats the process from step S31 of FIG. 5 in predetermined cycles until the supply of electric power is stopped.

In step S31, the first controller 60 determines whether the first changing request is set. In a case where the first changing request is set, the first controller 60 proceeds to step S32. In a case where the first changing request is not set, the first controller 60 ends the process. The first controller 60 determines that the first changing request is not set in step S31, for example, in a case where the changing condition has not been satisfied over a determination period or longer. The determination period is set to, for example, a period that is greater than the longest predetermined period calculated based on the first information. In step S32, the first controller 60 controls the first communicator 58 so that the first communicator 58 transmits the first signal to the second communicator 76, and then proceeds to step S33.

In step S33, the first controller 60 determines whether the second changing request is set. The first controller 60 determines that the second changing request is set in step S33, for example, if the changing condition for setting the first changing request is satisfied and then another changing condition is satisfied even in either one of a case where completion of shifting in response to the first changing request has not been received or a case where the predetermined period has not elapsed. In a case where the second changing request is set, the first controller 60 proceeds to step S34. In a case where the second changing request is not set, the first controller 60 ends the process. In step S34, the first controller 60 acquires the predetermined period based on the predetermined information, and then proceeds to step S35.

In step S35, the first controller 60 determines whether the first communicator 58 receives the changing completion signal. In a case where the first communicator 58 receives the changing completion signal, the first controller 60 proceeds to step S36. The first controller 60 repeats step S35 until the first communicator 58 receives the changing completion signal. In a case where the first communicator 58 does not receive the changing completion signal and a first period longer than the predetermined period elapses in step S35, the first controller 60 can proceed to step S37.

In step S36, the first controller 60 determines whether the predetermined period elapses. In a case where the predetermined period elapses, the first controller 60 proceeds to step S37. The first controller 60 repeats step S36 until the predetermined period elapses. In step S37, the first controller 60 controls the first communicator 58 so that the first communicator 58 transmits the second signal to the second communicator 76, and then proceeds to step S38

In step S38, the first controller 60 determines whether the second changing request is set. The first controller 60 determines that the second changing request is set in step S38, for example, if the changing condition for setting the first changing request is satisfied and then another changing condition is satisfied even in either one of a case where completion of shifting in response to the first changing request has not been received or a case where the predetermined period has not elapsed. In a case where the second changing request is set, the first controller 60 proceeds to step S34. The first controller 60 refers to the preceding second changing request as the first changing request and determines that the second changing request is set in step S38. In a case where the second changing request is not set, the first controller 60 ends the process.

Step S35 can be omitted in a case where the first controller 60 determines that changing of the transmission ratio R is completed in response to a signal directly received from the transmission state detector without using the transmission device 70. The first controller 60 can determine that changing of the transmission ratio R is completed based on whether the predetermined period has elapsed. In a case where the first controller 60 determines that changing of the transmission ratio R is based on whether the predetermined period has elapsed, step S35 can be omitted.

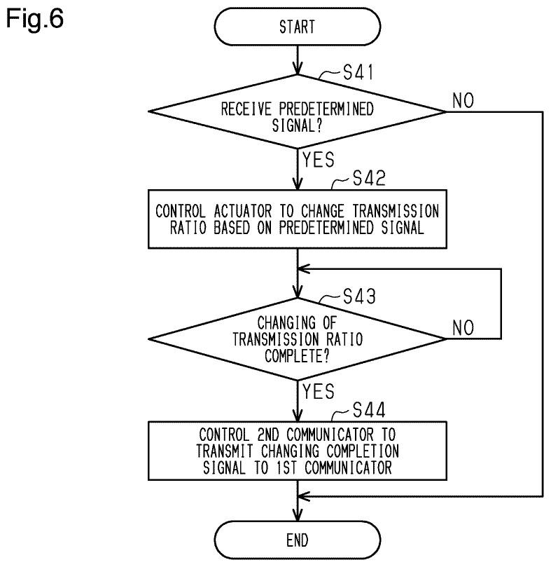

A process executed by the second controller 78 to control the actuator 74 in order to change the transmission ratio R will now be described with reference to FIG. 6. In a case where electric power is supplied to the second controller 78, for example, the second controller 78 starts the process of the flowchart shown in FIG. 6 from step S41. In a case where the process of the flowchart shown in FIG. 6 ends, for example, the second controller 78 repeats the process from step S41 of FIG. 6 in predetermined cycles until the supply of electric power is stopped.

In step S41, the second controller 78 determines whether the predetermined signal is received. In a case where the second controller 78 receives the predetermined signal, the second controller 78 proceeds to step S42. In a case where the second controller 78 does not receive the predetermined signal, the second controller 78 ends the process. In step S42, the second controller 78 controls the actuator 74 in order to change the transmission ratio R based on the predetermined signal, and then proceeds to step S43.

In step S43, the second controller 78 determines whether changing of the transmission ratio R is completed. The second controller 78 determines whether changing of the transmission ratio R is completed based on a signal from the transmission state detector. In a case where changing of the transmission ratio R is completed, the second controller 78 proceeds to step S44. In a case where changing of the transmission ratio R is not completed, the second controller 78 repeats step S43. In step S44, the second controller 78 controls the second communicator 76 so that the second communicator 76 transmits the changing completion signal to the first communicator 58, and then ends the process.

In a case where changing of the transmission ratio R is not completed in step S43, the second controller 78 can end the process after a changing determination period elapses. The changing determination period is set, for example, based on a period that allows for sufficiently completing changing of the transmission ratio R. In a case where changing of the transmission ratio R is not completed and the changing determination period elapses, the second controller 78 can be configured to determine that an anomaly has occurred in the transmission device 70.

### Second Embodiment

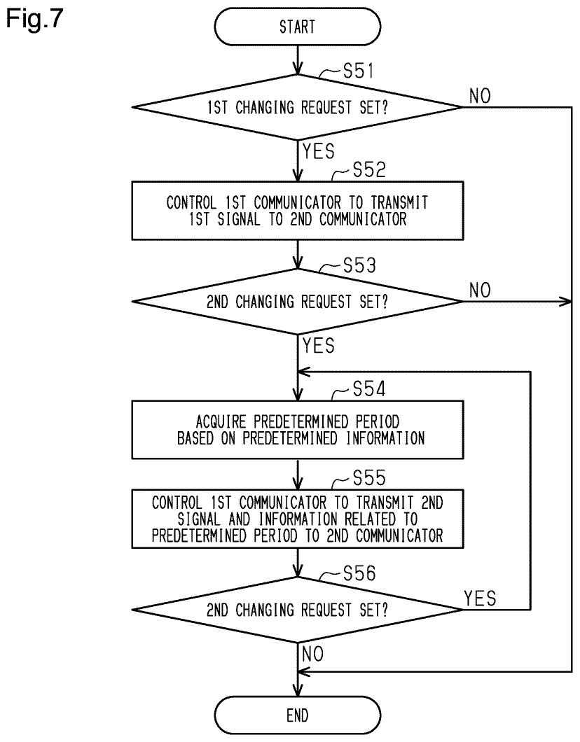

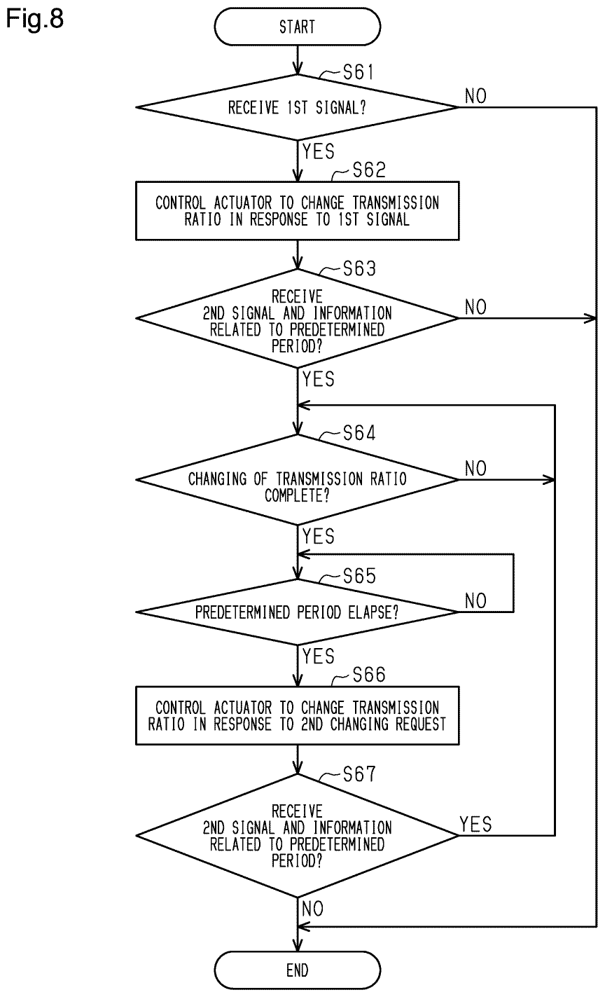

The assist device 50, the transmission device 70, and the control system 40 in accordance with a second embodiment will now be described with reference to FIGS. 7 and 8. Same reference numerals are given to those components of the assist device 50, the transmission device 70, and the control system 40 for in accordance with the second embodiment that are the same as the corresponding components in the first embodiment. Such components will not be described in detail.

In the second embodiment, for example, in a case where a changing request is set, the first controller 60 is configured to control the first communicator 58 so that the first communicator 58 immediately transmits the predetermined signal to the transmission device 70. In the second embodiment, for example, in a case where the predetermined signal is transmitted in response to the first changing request and then the second changing request is set, the first controller 60 is configured to control the first communicator 58 so that the first communicator 58 transmits the predetermined signal to the transmission device 70 in response to the second changing request. In the second embodiment, for example, in a case where the predetermined signal is transmitted in response to the first changing request and then the second changing request is set, the first controller 60 is configured to control the first communicator 58 so that the first communicator 58 transmits the predetermined signal to the transmission device 70 in response to the second changing request without waiting until the predetermined period elapses.

The predetermined signal of the present embodiment includes, for example, information related to the predetermined period. The predetermined signal includes, for example, a changing initiation signal and information related to the redetermined period. In a case where the predetermined signal is transmitted in response to the first changing request and then the second changing request is set before the predetermined period elapses from a time point at which changing of the transmission ratio R performed in response to the first changing request is completed, for example, the first controller 60 acquires the predetermined period based on the predetermined information. The first controller 60 is, for example, configured to acquire the predetermined period based on the predetermined information and then control the first communicator 58 so that the first communicator 58 immediately transmits the predetermined signal including the second changing request and the information related to the predetermined period to the transmission device 70.

The second controller 78 is, for example, configured to restrict driving of the actuator 74 after operation of the transmission device 70 ends until a wait period based on the predetermined period elapses. The predetermined signal can include information related to whether it is necessary to set the wait period based on the predetermined period.

A process executed by the first controller 60 of the second embodiment to transmit the predetermined signal including the predetermined period to the transmission device 70 will now be described with reference to FIG. 7. In a case where electric power is supplied to the first controller 60, for example, the first controller 60 starts the process of the flowchart shown in FIG. 7 from step S51. In a case where the process of the flowchart shown in FIG. 7 ends, for example, the first controller 60 repeats the process from step S51 of FIG. 7 in predetermined cycles until the supply of electric power is stopped.

In step S51, the first controller 60 determines whether the first changing request is set. In a case where the first changing request is set, the first controller 60 proceeds to step S32. In a case where the first changing request is not set, the first controller 60 ends the process. In step S52, the first controller 60 controls the first communicator 58 so that the first communicator 58 transmits the first signal to the second communicator 76, and then proceeds to step S53.

In step S53, the first controller 60 determines whether the second changing request is set. In a case where the second changing request is set, the first controller 60 proceeds to step S54. In a case where the second changing request is not set, the first controller 60 ends the process. In step S54, the first controller 60 acquires the predetermined period based on the predetermined information, and then proceeds to step S55.

In step S55, the first controller 60 controls the first communicator 58 so that the first communicator 58 transmits the second signal and the information related to the predetermined period to the second communicator 76, and then proceeds to step S56. In step S56, the first controller 60 determines whether the second changing request is issued. In a case where the second changing request is set, the first controller 60 proceeds to step S54. In a case where the second changing request is set, the first controller 60 refers to the preceding second changing request as a changing request corresponding to the first changing request, and executes the process from step S54. In a case where the second changing request is not set, the first controller 60 ends the process.

A process executed by the second controller 78 of the second embodiment to control the actuator 74 in order to change the transmission ratio R will now be described with reference to FIG. 8. In a case where electric power is supplied to the second controller 78, for example, the second controller 78 starts the process of the flowchart shown in FIG. 8 from step S61. In a case where the process of the flowchart shown in FIG. 8 ends, for example, the second controller 78 repeats the process from step S61 of FIG. 8 in predetermined cycles until the supply of electric power is stopped.

In step S61, the second controller 78 determines whether the first signal is received. In a case where the first signal is received, the second controller 78 proceeds to step S62. In a case where the first signal is not received, the second controller 78 ends the process. In step S62, the second controller 78 controls the actuator 74 in order to change the transmission ratio R in response to the first signal, and then proceeds to step S63.

In step S63, the second controller 78 determines whether the second signal and the information related to the predetermined period is received. In a case where the second signal and the information related to the predetermined period are received, the second controller 78 proceeds to step S64. In a case where the second signal and the information related to the predetermined period are not received, the second controller 78 ends the process.

In step S64, the second controller 78 determines whether changing of the transmission ratio R is completed. The second controller 78 determines whether changing of the transmission ratio R performed in response to the first signal is completed based on a signal from the transmission state detector. In a case where changing of the transmission ratio R is completed, the second controller 78 proceeds to step S65. In a case where changing of the transmission ratio R is not completed, the second controller 78 ends the process.

In step S65, the second controller 78 determines whether the predetermined period elapses. In a case where the predetermined period elapses, the second controller 78 proceeds to step S66. The second controller 78 executes step S65 until the predetermined period elapses. In step S66, the second controller 78 controls the actuator 74 in order to change the transmission ratio R in response to the second changing request, and then proceeds to step S67.

In step S67, the second controller 78 determines whether the second signal and the information related to the predetermined period are received. In a case where the second signal and the information related to the predetermined period are received, the second controller 78 proceeds to step S64. In a case where the second signal and the information related to the predetermined period are received, the second controller 78 refers to the second signal and the information related to the preceding predetermined period as the predetermined signal corresponding to the first signal, and executes the process from step S64. In a case where the second signal and the information related to the predetermined period are not received, the second controller 78 ends the process.

### Third Embodiment

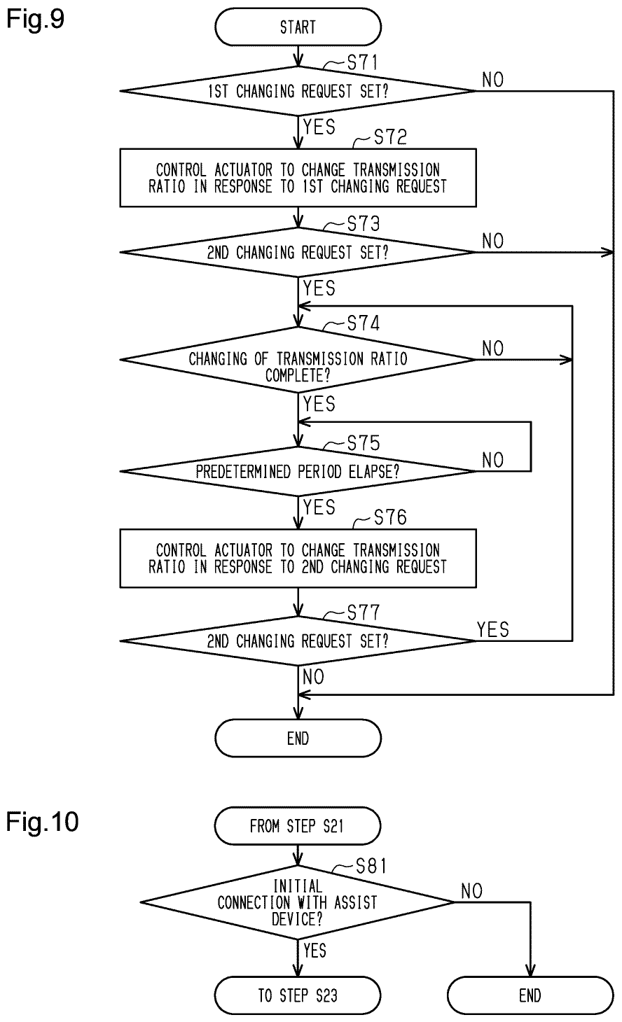

The assist device 50, the transmission device 70, and the control system 40 in accordance with a third embodiment will now be described with reference to FIG. 9. Same reference numerals are given to those components of the assist device 50, the transmission device 70, and the control system 40 in accordance with the third embodiment that are the same as the corresponding components in the first embodiment. Such components will not be described in detail.

The control system 40 of the present embodiment is configured so that the transmission device 70 changes the transmission ratio R in response to a changing request without using the assist device 50. The control system 40 of the present embodiment does not have to include the assist device 50.

The transmission device 70 of the third embodiment includes the actuator 74 and the second controller 78. The actuator 74 is configured to actuate the transmission device 70 in order to change the transmission ratio R. The second controller 78 is configured to control the actuator 74. In a case where the transmission device 70 is actuated to change the transmission ratio R, for example, the second controller 78 is configured to control the actuator 74 so that the actuator 74 delays operation initiation of the transmission device 70 for a predetermined period acquired based on the rotational amount of the sprockets 72, the present transmission ratio R that is presently set, and the changing direction of the transmission ratio R. The rotational amount is set for each of the transmission stages corresponding to the transmission ratio R.

In a case where the transmission device 70 is actuated to change the transmission ratio R, for example, the second controller 78 is configured to control the actuator 74 so that the actuator 74 delays operation initiation of the transmission device 70 for the predetermined period acquired based on the first information and the changing direction of the transmission ratio R. The predetermined information of the present embodiment includes every one of the rotational amount of the sprockets 72 set for each of the transmission stages corresponding to the transmission ratio R, the present transmission ratio R, and the changing direction of the transmission ratio R.

In a case where the first changing request is set as the changing condition is satisfied, for example, the second controller 78 is configured to control the actuator 74 so that the actuator 74 performs a changing action in response to the first changing request without waiting until a wait period elapses. In a case where the second changing request is set, for example, the second controller 78 is configured to control the actuator 74 so that the actuator 74 performs a changing action in response to the second changing request after the predetermined period elapses from a time point at which the second changing request is set.

In a case where the actuator 74 is controlled to change the transmission ratio R in response to the first changing request and then the second changing request is set, for example, the second controller 78 is configured to control the actuator 74 so that the actuator 74 changes the transmission ratio R in response to the second changing request in accordance with the predetermined period. In a case where the actuator 74 is controlled to change the transmission ratio R in response to the first changing request and then the second changing request is set before the predetermined period elapses from a time point at which changing of the transmission ratio R performed in response to the first changing request is completed, for example, the second controller 78 is configured to control the actuator 74 so that the actuator 74 changes the transmission ratio R in response to the second changing request after the predetermined period elapses.

A process executed by the second controller 78 of the third embodiment to control the actuator 74 in order to change the transmission ratio R will now be described with reference to FIG. 9. In a case where electric power is supplied to the second controller 78, for example, the second controller 78 starts the process of the flowchart shown in FIG. 9 from step S71. In a case where the process of the flowchart shown in FIG. 9 ends, for example, the second controller 78 repeats the process from step S71 of FIG. 9 in predetermined cycles until the supply of electric power is stopped.

In step S71, the second controller 78 determines whether the first changing request is set. In a case where the first changing request is set, the second controller 78 proceeds to step S72. In a case where the first changing request is not set, the second controller 78 ends the process. In step S72, the second controller 78 controls the actuator 74 so that the actuator 74 changes the transmission ratio R in response to the first changing request, and then proceeds to step S73.

In step S73, the second controller 78 determines whether the second changing request is set. In a case where the second changing request is set, the second controller 78 proceeds to step S74. In a case where the second changing request is not set, the second controller 78 ends the process. In step S74, the second controller 78 determines whether changing of the transmission ratio R is completed. In a case where changing of the transmission ratio R is completed, the second controller 78 proceeds to step S75. The second controller 78 repeats step S74 until changing of the transmission ratio R is completed. In a case where a second period longer than the predetermined period elapses in step S74, the second controller 78 can proceed to step S76.

In step S75, the second controller 78 determines whether the predetermined period elapses. In a case where the predetermined period elapses, the second controller 78 proceeds to step S76. The second controller 78 repeats step S75 until the predetermined period elapses. In step S76, the second controller 78 controls the actuator 74 so that the actuator 74 changes the transmission ratio R in response to the second changing request, and then proceeds to step S77.

In step S77, the second controller 78 determines whether the second changing request is set. In a case where the second changing request is set, the second controller 78 proceeds to step S74. The second changing request in step S77 corresponds to a second changing request in a case where the second changing request in step S73 serves as a changing request corresponding to the first changing request. In a case where the second changing request is not set, the second controller 78 ends the process.

### Modifications

The description related with the above embodiments exemplifies, without any intention to limit, applicable forms of an assist device for a human-powered vehicle, a transmission device for a human-powered vehicle, and a control system for a human-powered vehicle in accordance with the present disclosure. The assist device for a human-powered vehicle, the transmission device for a human-powered vehicle, and the control system for a human-powered vehicle according to the present disclosure are applicable to, for example, modifications of the above embodiments that are described below and combinations of at least two of the modifications that do not contradict each other. In the modifications described hereafter, same reference numerals are given to those components that are the same as the corresponding components of the above embodiments. Such components will not be described in detail.

The assist operating unit 52 can be provided in the drive unit 54. At least one of the first controller 60, the first communicator 58, and the first storage 62 can be provided in the drive unit 54.

In the first and second embodiments, the second controller 78 can be configured to transmit the predetermined information based on a determination result of whether initial connection with the assist device 50 is established. In the present modification, for example, the second controller 78 can execute step S81 shown in FIG. 10, instead of step S22. In step S81, the second controller 78 determines whether the second controller 78 establishes initial connection with the assist device 50. In a case where the second controller 78 determines that the second controller 78 establishes initial connection with the assist device 50 in step S81, the second controller 78 proceeds to step S23. In a case where the second controller 78 determines that the second controller 78 does not establish initial connection with the assist device 50 in step S81, the second controller 78 ends the process. In the present modification, the first controller 60 does not have to transmit a predetermined-information sending request. In the present modification, for example, step S13 of FIG. 3 is omitted.

In the first and second embodiments, the predetermined information does not have to include the changing direction of the transmission ratio R. In the present modification, for example, the same predetermined period is set for each of a case where the transmission stage is changed from the “m”th stage to the “m+1”th stage and a case where the transmission stage is changed from the “m+1”th stage to the “m”th stage. In this case, “m” is a natural number greater than or equal to one. In the present modification, also, a predetermined period sufficient for changing the transmission ratio R in response to the first changing request is set in each of a case where the transmission stage is changed from the “m”th stage to the “m+1”th stage and a case where the transmission stage is changed from the “m+1”th stage to the “m”th stage. Thus, the transmission device 70 changes the transmission ratio R in a preferred manner.

In the first embodiment, the predetermined period can include a first predetermined period for the first changing request and a second predetermined period for the second changing request. For example, the second predetermined period corresponds to the predetermined period described in each of the embodiments. For example, the first predetermined period differs from the second predetermined period. In a case where the changing request is the first changing request, for example, the first controller 60 is configured to control the first communicator 58 so that the first communicator 58 transmits the predetermined signal to the transmission device 70 after the first predetermined period elapses. The first predetermined period is, for example, a period that continues until the chain 28A is moved to a position corresponding to the transmission facilitation region provided on each of the sprockets 72. The first predetermined period can be, for example, a period set based on a time point at which the human driving force input to the crank axle 12A becomes equal to a minimum peak value.

In the second embodiment, the predetermined period can include a first predetermined period for the first changing request and a second predetermined period for the second changing request. In a case where the changing request is the first changing request, for example, the first controller 60 can include information related to the predetermined period in the predetermined signal transmitted in response to the first changing request. In a case where the second controller 78 receives the predetermined signal in response to the first changing request, the second controller 78 can be configured to control the actuator 74 so that the actuator 74 initiates a changing action in response to the first changing request after the predetermined period elapses.

In the third embodiment, the predetermined period can include a first predetermined period for the first changing request and a second predetermined period for the second changing request. In a case where the changing request is the first changing request, for example, the second controller 78 can be configured to control the actuator 74 so that the actuator 74 initiates a changing action after the predetermined period elapses.

The transmission device 70 can include an internal transmission device. In a case where the transmission device 70 includes an internal transmission device, for example, the internal transmission device is provided in a hub of the rear wheel. The internal transmission device can include a continuously variable transmission (CVT). In a case where the transmission device 70 includes an internal transmission device, for example, the predetermined period is calculated based on the rotational speed C of the crank axle 12A and upper and bottom dead centers of the crank 12. The first controller 60 uses the rotational speed C of the crank axle 12A to calculate a predetermined time that continues until the crank 12 reaches the upper and bottom dead centers as the predetermined period.

The second controller can be provided on a wireless communication repeater accommodated in a housing that differs from the transmission device 70.

In the first embodiment, the second controller 78 can be configured to determine whether it is necessary that the assist device 50 transmits the predetermined signal to the transmission device 70 in accordance with the predetermined period. In the present modification, for example, the transmission device 70 is configured to transmit to the assist device 50 information for determining whether it is necessary that the assist device 50 transmits the predetermined signal to the transmission device 70 in accordance with the predetermined period. The information for determining whether it is necessary that the assist device 50 transmits the predetermined signal to the transmission device 70 in accordance with the predetermined period is transmitted from the transmission device 70 to the assist device 50, for example, together with the predetermined information.

As long as the assist device 50 for a human-powered vehicle is configured as described below, any other configuration can be omitted. The assist device 50 includes the assist motor 56, the first communicator 58, and the first controller 60. The assist motor 56 is configured to assist in propulsion of the human-powered vehicle 10. The first communicator 58 is configured to communicate with the transmission device 70 and receive the first information from the transmission device 70. The transmission device 70 is configured to change the transmission ratio R of the human-powered vehicle 10. The first controller 60 is configured to control the first communicator 58 so that the first communicator 58 transmits the predetermined signal to the transmission device 70 in order to actuate the transmission device 70 and change the transmission ratio R. The transmission device 70 is configured to change the transmission ratio R by moving the chain 28A between two adjacent sprockets 72 of the plurality of sprockets 72. The first controller 60 is configured to acquire the predetermined period based on the first information received by the first communicator 58. The first controller 60 is configured to control the first communicator 58 so that the first communicator 58 transmits the predetermined signal to the transmission device 70 in accordance with the predetermined period. The first information includes the information related to the plurality of transmission stages corresponding to the transmission ratio R and the rotational amount of the plurality of sprockets 72.

As long as the assist device 50 for a human-powered vehicle is configured as described below, any other configuration can be omitted. The assist device 50 includes the assist motor 56, the first communicator 58, and the first controller 60. The assist motor 56 is configured to assist in propulsion of the human-powered vehicle 10. The first communicator 58 is configured to wirelessly communicate with the transmission device 70 and receive the predetermined information from the transmission device 70. The transmission device 70 is configured to change the transmission ratio R of the human-powered vehicle 10. The first controller 60 is configured to control the first communicator 58 so that the first communicator 58 transmits the predetermined signal to the transmission device 70 in order to actuate the transmission device 70 and change the transmission ratio R. The first controller 60 is configured to acquire the predetermined period based on the predetermined information received by the first communicator 58. The first controller 60 is configured to control the first communicator 58 so that the first communicator 58 transmits the predetermined signal to the transmission device 70 in accordance with the predetermined period.

As long as the assist device 50 for a human-powered vehicle is configured as described below, any other configuration can be omitted. The assist device 50 includes the assist motor 56, the first communicator 58, and the first controller 60. The assist motor 56 is configured to assist in propulsion of the human-powered vehicle 10. The first communicator 58 is configured to wirelessly communicate with the transmission device 70 that is configured to change the transmission ratio R of the human-powered vehicle 10. The first controller 60 is configured to control the first communicator 58 so that the first communicator 58 transmits the predetermined signal to the transmission device 70 in order to actuate the transmission device 70 and change the transmission ratio R. The transmission device 70 is configured to change the transmission ratio R by moving the chain 28A between two adjacent sprockets 72 of the plurality of sprockets 72. The first controller 60 is configured to control the first communicator 58 so that the first communicator 58 transmits the predetermined signal to the transmission device 70 in accordance with the predetermined period. The first controller 60 is configured to acquire the predetermined period based on the rotational amount of the plurality of sprockets 72, the present transmission ratio R that is presently set, and the changing direction of the transmission ratio R. The rotational amount is set for each of the plurality of transmission stages corresponding to the transmission ratio R.

As long as the transmission device 70 for a human-powered vehicle is configured as described below, any other configuration can be omitted. The transmission device 70 is configured to change the transmission ratio R of the human-powered vehicle 10 by moving the chain 28A between two adjacent sprockets 72 of the plurality of sprockets 72. The transmission device 70 includes the actuator 74, the second communicator 76, and the second controller 78. The actuator 74 is configured to actuate the transmission device 70 and change the transmission ratio R. The second communicator 76 is configured to communicate with the assist device 50 that assists in propulsion of the human-powered vehicle 10 to receive the predetermined signal from the assist device 50 and transmit the first information to the assist device 50. The second controller 78 is configured to control the actuator 74 based on the predetermined signal received by the second communicator 76. The predetermined signal is transmitted to the second communicator 76 in accordance with the predetermined period acquired by the assist device 50 based on the first information. The first information includes the information related to the plurality of transmission stages corresponding to the transmission ratio R and the rotational amount of the plurality of sprockets 72.

As long as the transmission device 70 for a human-powered vehicle is configured as described below, any other configuration can be omitted. The transmission device 70 is configured to change the transmission ratio R of the human-powered vehicle 10. The transmission device 70 includes the actuator 74, the second communicator 76, and the second controller 78. The actuator 74 is configured to actuate the transmission device 70 and change the transmission ratio R. The second communicator 76 is configured to wirelessly communicate with the assist device 50 that assists in propulsion of the human-powered vehicle 10 to receive the predetermined signal from the assist device 50 and transmit the predetermined information to the assist device 50. The second controller 78 is configured to control the actuator 74 based on the predetermined signal received by the second communicator 76. The predetermined signal is transmitted to the second communicator 76 in accordance with the predetermined period acquired by the assist device 50 based on the predetermined information.

As long as the transmission device 70 for a human-powered vehicle is configured as described below, any other configuration can be omitted. The transmission device 70 is configured to change the transmission ratio R of the human-powered vehicle 10 by moving the chain 28A between two adjacent sprockets 72 of the plurality of sprockets 72. The transmission device 70 includes the actuator 74, the second communicator 76, and the second controller 78. The actuator 74 is configured to actuate the transmission device 70 and change the transmission ratio R. The second communicator 76 is configured to wirelessly communicate with the assist device 50 that assists in propulsion of the human-powered vehicle 10 to receive the predetermined signal from the assist device 50. The second controller 78 is configured to control the actuator 74 based on the predetermined signal received by the second communicator 76. The predetermined signal is transmitted to the second communicator 76 in accordance with the predetermined period acquired by the assist device 50. The predetermined period is acquired based on the rotational amount of the plurality of sprockets 72, the present transmission ratio R that is presently set, and the changing direction of the transmission ratio R. The rotational amount is set for each of the plurality of transmission stages corresponding to the transmission ratio R.

As long as the transmission device 70 for a human-powered vehicle is configured as described below, any other configuration can be omitted. The transmission device 70 is configured to change the transmission ratio R of the human-powered vehicle 10 by moving the chain 28A between two adjacent sprockets 72 of the plurality of sprockets 72. The transmission device 70 includes the actuator 74 and the second controller 78. The actuator 74 is configured to actuate the transmission device 70 and change the transmission ratio R. The second controller 78 is configured to control the actuator 74. In a case where the transmission device 70 is actuated to change the transmission ratio R, the second controller 78 is configured to control the actuator 74 so that the actuator 74 delays operation initiation of the transmission device 70 for predetermined period acquired based on the rotational amount of the plurality of sprockets 72, the present transmission ratio R that is presently set, and the changing direction of the transmission ratio R. The rotational amount is set for each of the plurality of transmission stages corresponding to the transmission ratio R.

The phrase “at least one of” as used in this disclosure means “one or more” of a desired choice. For one example, the phrase “at least one of” as used in this disclosure means “only one single choice” or “both of two choices” if the number of its choices is two. For another example, the phrase “at least one of” as used in this disclosure means “only one single choice” or “any combination of equal to or more than two choices” if the number of its choices is equal to or more than three. Also, the term “and/or” as used in this disclosure means “either one or both of”. For instance, the phrase “at least one of A and B” encompasses (1) A alone, (2), B alone, and (3) both A and B. The phrase “at least one of A, B, and C” encompasses (1) A alone, (2), B alone, (3) C alone, (4) both A and B, (5) both B and C, (6) both A and C, and (7) all A, B, and C. In other words, the phrase “at least one of A and B” does not mean “at least one of A and at least one of B” in this disclosure.

Ordinal numerals such as “first”, “second”, and “third” are used in this disclosure only to distinguish members having the same name from one another and are not intended to have any special meaning.

### DESCRIPTION OF REFERENCE CHARACTERS

10) human-powered vehicle, 12A) crank axle, 28A) chain, 36) battery, 40) control system, 50) assist device, 56) assist motor, 58) first communicator, 60) first controller, 70) transmission device, 72) sprocket, 74) actuator, 76) second communicator, 78) second controller, 82) transmission operating device, 84) third communicator.

What is claimed is:

1. An assist device for a human-powered vehicle, the assist device comprising:
an assist motor configured to assist in propulsion of the human-powered vehicle;
a first communicator configured to communicate with a transmission device and receive first information from the transmission device, the transmission device being configured to change a transmission ratio of the human-powered vehicle; and
a first controller configured to control the first communicator so that the first communicator transmits a predetermined signal to the transmission device in order to actuate the transmission device and change the transmission ratio,
the transmission device being configured to change the transmission ratio by moving a chain between two adjacent sprockets of a plurality of sprockets,
the first controller being configured to acquire a predetermined period based on the first information received by the first communicator,
the first controller being configured to control the first communicator so that the first communicator transmits the predetermined signal to the transmission device in accordance with the predetermined period,
the first information including information related to a plurality of transmission stages corresponding to the transmission ratio and a rotational amount of the plurality of sprockets.

2. An assist device for a human-powered vehicle, the assist device comprising:
an assist motor configured to assist in propulsion of the human-powered vehicle;
a first communicator configured to wirelessly communicate with a transmission device and receive predetermined information from the transmission device, the transmission device being configured to change a transmission ratio of the human-powered vehicle; and
a first controller configured to control the first communicator so that the first communicator transmits a predetermined signal to the transmission device in order to actuate the transmission device and change the transmission ratio,
the first controller being configured to acquire a predetermined period based on the predetermined information received by the first communicator,
the first controller being configured to control the first communicator so that the first communicator transmits the predetermined signal to the transmission device in accordance with the predetermined period.

3. The assist device according to claim 2, wherein
the transmission device is configured to change the transmission ratio by moving a chain between two adjacent sprockets of a plurality of sprockets,
the predetermined information includes at least one of first information and second information,
the first information includes information related to a plurality of transmission stages corresponding to the transmission ratio and a rotational amount of the plurality of sprockets, and
the second information includes at least one of identification information of the transmission device and identification information of a set of the plurality of sprockets.

4. The assist device according to claim 3, wherein
the predetermined information includes the first information, and
the first controller is configured to acquire the predetermined period based on the first information and a changing direction of the transmission ratio.

5. The assist device according to claim 3, wherein
the predetermined information includes the first information, and
the first information includes a table indicating a corresponding relationship of the plurality of transmission stages and the rotational amount.

6. An assist device for a human-powered vehicle, the assist device comprising:
an assist motor configured to assist in propulsion of the human-powered vehicle;
a first communicator configured to wirelessly communicate with a transmission device that is configured to change a transmission ratio of the human-powered vehicle; and
a first controller configured to control the first communicator so that the first communicator transmits a predetermined signal to the transmission device in order to actuate the transmission device and change the transmission ratio,
the transmission device being configured to change the transmission ratio by moving a chain between two adjacent sprockets of a plurality of sprockets,
the first controller being configured to control the first communicator so that the first communicator transmits the predetermined signal to the transmission device in accordance with the predetermined period,
the first controller being configured to acquire the predetermined period based on a rotational amount of the plurality of sprockets, the rotational amount being set for each of the plurality of transmission stages corresponding to the transmission ratio, a present transmission ratio that is presently set, and a changing direction of the transmission ratio.

7. The assist device according to claim 1, wherein
in a case where the predetermined signal is transmitted in response to a first changing request and then a second changing request is set, the first controller is configured to control the first communicator so that the first communicator transmits the predetermined signal to the transmission device in response to the second changing request in accordance with the predetermined period.

8. The assist device according to claim 1, wherein
in a case where the predetermined signal is transmitted in response to a first changing request and then a second changing request is set before the predetermined period elapses from a time point at which changing of the transmission ratio performed in response to the first changing request is completed, the first controller is configured to control the first communicator so that the first communicator transmits the predetermined signal to the transmission device in response to the second changing request after the predetermined period elapses.

9. The assist device according to claim 1, wherein
the rotational amount is set based on a transmission facilitation region provided on each of the plurality of sprockets.

10. The assist device according to claim 1, wherein
the predetermined period is acquired based on at least one of a rotational speed of a crank axle of the human-powered vehicle and a vehicle speed.

11. A transmission device for a human-powered vehicle, the transmission device being configured to change a transmission ratio of the human-powered vehicle by moving a chain between two adjacent sprockets of a plurality of sprockets, the transmission device comprising:
an actuator configured to actuate the transmission device and change the transmission ratio;
a second communicator configured to communicate with an assist device that assists in propulsion of the human-powered vehicle to receive a predetermined signal from the assist device and transmit first information to the assist device; and
a second controller configured to control the actuator based on the predetermined signal received by the second communicator,
the predetermined signal being transmitted to the second communicator in accordance with a predetermined period acquired by the assist device based on the first information, and
the first information including information related to a plurality of transmission stages corresponding to the transmission ratio and a rotational amount of the plurality of sprockets.

12. The transmission device according to claim 11, wherein
in a case where the second communicator is connected to the assist device in a manner allowing for communication, the second controller is configured to control the second communicator so that the second communicator transmits the first information to the assist device.

13. A transmission device for a human-powered vehicle, the transmission device configured to change a transmission ratio of the human-powered vehicle, the transmission device comprising:
an actuator configured to actuate the transmission device and change the transmission ratio;
a second communicator configured to wirelessly communicate with an assist device that assists in propulsion of the human-powered vehicle to receive a predetermined signal from the assist device and transmit predetermined information to the assist device; and
a second controller configured to control the actuator based on the predetermined signal received by the second communicator,
the predetermined signal being transmitted to the second communicator in accordance with a predetermined period acquired by the assist device based on the predetermined information.

14. The transmission device according to claim 13, wherein
the transmission device is configured to change the transmission ratio by moving a chain between two adjacent sprockets of a plurality of sprockets,
the predetermined information includes at least one of first information and second information,
the first information includes information related to a plurality of transmission stages corresponding to the transmission ratio and a rotational amount of the plurality of sprockets, and
the second information includes at least one of identification information of the transmission device and identification information of a set of the plurality of sprockets.

15. The transmission device according to claim 14, wherein
the predetermined information includes the first information, and
the assist device is configured to acquire the predetermined period based on the first information and a changing direction of the transmission ratio.

16. The transmission device according to claim 14, wherein
the predetermined information includes the first information, and
the first information includes a table indicating a corresponding relationship of the plurality of transmission stages and the rotational amount.

17. The transmission device according to claim 13, wherein
in a case where the second communicator is connected to the assist device in a manner allowing for communication, the second controller is configured to control the second communicator so that the second communicator transmits the predetermined information to the assist device.

18. A transmission device for a human-powered vehicle, the transmission device configured to change a transmission ratio of the human-powered vehicle by moving a chain between two adjacent sprockets of a plurality of sprockets, the transmission device comprising:
an actuator configured to actuate the transmission device and change the transmission ratio;
a second communicator configured to wirelessly communicate with an assist device that assists in propulsion of the human-powered vehicle to receive a predetermined signal from the assist device; and
a second controller configured to control the actuator based on the predetermined signal received by the second communicator,
the predetermined signal being transmitted to the second communicator in accordance with a predetermined period acquired by the assist device, and
the predetermined period being acquired based on a rotational amount of the plurality of sprockets, the rotational amount being set for each of the plurality of transmission stages corresponding to the transmission ratio, a present transmission ratio that is presently set, and a changing direction of the transmission ratio.

19. The transmission device according to claim 11, wherein
in a case where a changing request is set, the assist device is configured to transmit the predetermined signal to the second communicator after the predetermined period elapses from a time point at which the changing request is set, and
the second controller is configured to control the actuator in order to change the transmission ratio in a case where the predetermined signal is received.

20. The transmission device according to claim 11, wherein
the predetermined signal includes information related to the predetermined period, and
the second controller is configured to restrict driving of the actuator after operation of the transmission device ends until a wait period based on the predetermined period elapses.

21. A transmission device for a human-powered vehicle, the transmission device being configured to change a transmission ratio of the human-powered vehicle by moving a chain between two adjacent sprockets of a plurality of sprockets, the transmission device comprising:
an actuator configured to actuate the transmission device and change the transmission ratio;
a second controller configured to control the actuator,
in a case where the transmission device is actuated to change the transmission ratio, the second controller being configured to control the actuator so that the actuator delays operation initiation of the transmission device for a predetermined period acquired based on a rotational amount of the plurality of sprockets, the rotational amount being set for each of the plurality of transmission stages corresponding to the transmission ratio, a present transmission ratio that is presently set, and a changing direction of the transmission ratio.

22. The transmission device according to claim 21, wherein
in a case where the actuator is controlled to change the transmission ratio in response to a first changing request and then a second changing request is set, the second controller is configured to control the actuator so that the actuator changes the transmission ratio in response to the second changing request in accordance with the predetermined period.

23. The transmission device according to claim 21, wherein
in a case where the actuator is controlled to change the transmission ratio in response to a first changing request and then a second changing request is set before the predetermined period elapses from a time point at which changing of the transmission ratio performed in response to the first changing request is completed, the second controller is configured to control the actuator so that the actuator changes the transmission ratio in response to the second changing request after the predetermined period elapses.

24. The transmission device according to claim 11, wherein
the rotational amount is set based on a transmission facilitation region provided on each of the plurality of sprockets.

25. The transmission device according to claim 11, wherein
the predetermined period is acquired based on at least one of a rotational speed of a crank axle of the human-powered vehicle and a vehicle speed.

26. A control system for a human-powered vehicle, the control system comprising:
the assist device according to claim 1; and
the transmission device.

27. The control system according to claim 26, further comprising:
a transmission operating device configured to operate the transmission device, wherein
the transmission device includes a third communicator configured to communicate with the transmission operating device through a first communication protocol, and
the assist device is configured to communicate with the transmission device through a second communication protocol that differs from the first communication protocol.

28. The control system according to claim 26, wherein
the transmission device and the assist device are supplied with electric power from a common battery.
